(19) United States
(12) Patent Application Publication
(10) Pub. No.: US 2012/0132049 A1
(43) Pub. Date: May 31, 2012

(54) CUTTING GUIDE

(76) Inventor: Willy BOKELAAR, Colonial Heights, VA (US)

(21) Appl. No.: 13/307,124

(22) Filed: Nov. 30, 2011

Related U.S. Application Data
(60) Provisional application No. 61/417,951, filed on Nov. 30, 2010.
(60) Provisional application No. 61/451,440, filed on Mar. 10, 2011.
(60) Provisional application No. 61/511,198, filed on Jul. 25, 2011.

(51) Int. Cl. B27B 9/04

(52) U.S. Cl. 83/574

(57) ABSTRACT

A cutting guide includes a central support, a plurality of legs supporting the central support, and a guide rail disposed on the central support. The guide rail defines a first end and a second end. A carriage is slidably disposable in the guide rail. The carriage is adapted to receive a cutting device thereon and is disposed within the guide rail to be movable from the first end to the second end.

### CROSS-REFERENCE TO RELATED APPLICATION(S)

This is a United States Non-Provisional Patent Application that relies for priority on U.S. Provisional Patent Application Ser. No. 61/417,951, filed on Nov. 30, 2010, U.S. Provisional Patent Application Ser. No. 61/451,440, filed on Mar. 10, 2011, and U.S. Provisional Patent Application Ser. No. 61/511,198, filed on Jul. 25, 2011, the contents of all of which are incorporated herein by reference.

### FIELD OF THE INVENTION

The present invention concerns a guide for a cutting device. The cutting device may be a saw, such as a circular saw. More specifically, the present invention provides a cutting guide that permits cutting and/or shaping of oversized items, such as siding and plywood, among others.

### BACKGROUND OF THE INVENTION

The construction industry has available to it many different devices that assist with the cutting and/or shaping of various materials including oversized materials.

Oversized materials include, but are not limited to plywood and siding panels, both of which tend to be many feet long and several feet wide. Due to the sizes of these materials, they are cumbersome to manipulate and difficult to cut to proper sizes.

Many prior art tools designed to help handle these types of materials are based on a traditional work horse that has been modified to include apparatuses that assist with cutting the oversized construction material. These devices maintain the construction material in a horizontal plane.

In addition, these devices incorporate a fixed saw into the apparatus and require the user to move the construction material against the cutting blade of the saw. In other words, the construction of prior art devices requires that the object to be cut (i.e., the construction material) be manipulated by the user. As should be apparent, manipulating large, bulky objects into a saw blade presents challenges to the user.

Another disadvantage to this traditional approach lies in the complexity of the devices. In order to ensure that the construction materials are cut to appropriate dimensions, the prior art devices incorporate complex devices that allow the user to select a particular angle for a particular cut of the construction material.

A further disadvantage to approach taken in the prior art lies in the weight associated with these traditional devices. Specifically, it has been observed that traditional devices often weigh fifty pounds, seventy pounds, one hundred pounds, or more. While weight is not typically a problem when the apparatus is positioned in a fixed location, weight becomes an issue when the device is required to be moved between plural locations within a particular worksite.

It has been observed, therefore, that a more portable device for cutting construction materials may be of some utility at construction sites.

### SUMMARY OF THE INVENTION

The present invention intended to address one or more of the deficiencies in the prior art.

The present invention provides for a cutting guide that includes a central support and a plurality of legs supporting the central support. A removable guide rail is disposed on the central support. The guide rail defines a first end and a second end. A carriage is slidably disposable in the guide rail. The carriage is adapted to receive a cutting device thereon and the carriage is disposable within the guide rail to be movable between the first end and the second end.

In one contemplated embodiment of the present invention, the guide rail includes a body with a top surface, a first side edge, and a second side edge, a first side extending upwardly from the top surface of the guide rail adjacent the first side edge, and a second side extending upwardly from the top surface adjacent to the second side edge. The body, the first side, and the second side define a U-shaped channel for receipt of the carriage.

In another contemplated embodiment, the first side of the guide rail extends upwardly from the top surface at the first side edge of the guide rail, and the second side extends upwardly from the top surface at the second side edge at a predetermined distance toward a center of the guide rail from the second edge. The second side and the second side edge define a cutting guide thereby.

It is contemplated that the guide rail may include a first channel defined within the first side and a second channel defined within the second side.

If so, the guide rail may be provided with an extension. The extension is contemplated to include an end segment connecting a first leg and a second leg to one another forming a U-shape. The first and second legs may be positioned within the first and second channels, permitting the extension to slidably engage the guide rail.

It is also contemplated that the cutting guide will include a guide carriage slidably disposed on the central support. The guide rail may be pivotally connected to the guide carriage to permit the guide rail to be angularly positioned with respect to the central support.

Additionally, the present invention encompasses a cutting guide with a first upright connected to the central support at a first end and a second upright connected to the central support at a second end. The first and second uprights are angled with respect to horizontal such that a construction material place thereon is angled with respect to the horizontal.

In another embodiment, at least one horizontal frame element is connected between the first upright and the second upright, thereby forming a frame connected to the central support.

A further embodiment of the cutting guide of the present invention includes a guide rail with a first lip extending from a top edge of the first side toward a center of the guide rail and a second lip extending from a top edge of the second side toward the center of the guide rail. The first and second lips retain the carriage within the guide rail.

As for materials, the central support, the legs, the guide rail, and the carriage may be made from at least one a material selected from a group comprising aluminum, aluminum alloys, metal, plastic, fiberglass, composite materials, steel, iron, iron alloys, titanium, titanium alloys, magnesium, magnesium alloys, beryllium, beryllium alloys, carbon fiber, and aramid fiber. Other materials also may be employed.

It is contemplated that the guide may include a protractor disposed between the guide rail and the guide carriage to provide an indication of an angle of displacement of the guide rail with respect to a vertical position.

Separately, the guide rail may include a primary element and a secondary element hingedly connected to the primary element such that the secondary element folds over the primary element when in a closed position and unfolds adjacent to the primary element when in an opened position.

Where the guide rail includes primary and secondary elements, it is contemplated that the guide rail may include a latch to secure the secondary element against the primary element when in the closed position.

The guide rail also may include a ramp disposed at one end. The ramp may be adjustable to a predetermined angle with respect to the guide rail. The ramp is contemplated to facilitate introduction of the saw guide to the guide rail.

Where a ramp is included, the ramp may be hingedly connected to the guide rail at a predetermined distance inward from one end of the guide rail.

In another embodiment, the cutting guide may include at least one extension slidably connected to the guide rail, the at least one extension comprising at least one plate providing a surface area for securement of the guide rail to the substrate via a fastener.

The cutting guide of the present invention also may include a plurality of legs that comprise at least two front legs and two rear legs. If so, each front leg is connected pivotally to each rear leg. The front and rear legs may be connected operatively to two chucks, which cooperate with one another to secure the front and rear legs to the central support when the legs are in a closed position and which cooperate with one another to release the front and rear legs from the central support when in an opened position.

In the embodiment with front a rear legs connected to chucks, a push rod may be operatively connected to the chucks for applying a compressive force on the chucks when the front and rear legs are in the closed position.

It is also contemplated that the cutting guide may include at least one extender slidably disposed within one end of the central support. The extender may be slid out from the central support to extend a length of the central support.

The cutting guide of the present invention also may incorporate a dust removal apparatus. If so, the dust removal apparatus is contemplated to include an upper coupling connected to the carriage, the upper coupling defining an upper opening at one end, a lower coupling connected adjacent to the upper coupling, the lower coupling defining a lower opening at one end, consistent with the upper opening, an upper discharge tube connected to the upper coupling, a lower discharge tube connected to the lower coupling, and a combiner connecting the upper discharge tube to the lower discharge tube, such that dust flowing through the upper and lower discharge tubes exits via the combiner.

Other aspects of the invention will become apparent to those skilled in the art after appreciating the details presented below.

### BRIEF DESCRIPTION OF THE DRAWING(S)

The present invention is described in connection with the drawing appended hereto, in which:

FIG. 1 is a perspective illustration of a first embodiment of a cutting guide according to the present invention;

FIG. 2 is an enlarged, perspective illustration of an extension component of the cutting guide that is depicted in FIG. 1;

FIG. 3 is an enlarged, perspective illustration of a guide rail component of the cutting guide that is shown in FIG. 1;

FIG. 4 is an enlarged, perspective illustration of a carriage component of the cutting guide that is shown in FIG. 1;

FIG. 5 is an enlarged, perspective illustration of a work horse component of the cutting guide depicted in FIG. 1;

FIG. 6 is a perspective illustration of another embodiment of the cutting guide of the present invention;

FIG. 7 is a top view of the cutting guide illustrated in FIG. 1;

FIG. 8 is a side view of the cutting guide depicted in FIG. 1;

FIG. 9 is an end view of the cutting guide shown in FIG. 1;

FIG. 10 is a cross-sectional view of the cutting guide shown in FIG. 1, the cross-section being taken along line 10-10 in FIG. 8;

FIG. 11 is an enlarged, cross-sectional view of a portion of the cutting guide depicted in FIG. 1, the enlargement being taken from the circled area labeled 11-11 in FIG. 10;

FIG. 12 is a cross-sectional end view of one contemplated embodiment for the rail guide according to the present invention;

FIG. 13 is a cross-sectional end view of another contemplated embodiment for the rail guide of the present invention;

FIG. 14 is a cross-sectional end view of yet another contemplated embodiment for the rail guide of the present invention;

FIG. 15 is a simplified, perspective illustration of the cutting guide depicted in FIG. 1, a construction material or substrate being illustrated in connection therewith;

FIG. 16 also is a simplified, perspective illustration like FIG. 15, but taken from a slightly different perspective for illustrative purposes;

FIG. 17 is a perspective illustration of a further embodiment of a cutting guide according to the present invention;

FIG. 18 is a perspective illustration of the cutting guide depicted in FIG. 17, with extension components being added to support the construction material;

FIG. 19 is a perspective illustration of one further contemplated embodiment of the cutting guide of the present invention;

FIG. 20 is a perspective illustration of the cutting guide depicted in FIG. 19, with the guide rail and extension being shown at a different angular position than depicted in FIG. 19;

FIG. 21 is a perspective illustration of the cutting guide shown in FIG. 19, with a construction material being added for reference and the guide rail being oriented substantially vertically;

FIG. 22 is a perspective illustration of the cutting guide shown in FIG. 19, with a construction material being added for reference and the guide rail and extension being oriented at an angle with respect to horizontal;

FIG. 23 is a perspective illustration of the cutting guide shown in FIG. 19, with a construction material being added for reference and the guide rail and extension being oriented substantially horizontally;

FIG. 24 is a perspective view of another embodiment of a cutting guide according to the present invention;

FIG. 25 is a perspective illustration of a guide rail for use with the cutting guide of the present invention that is shown in FIG. 24;

FIG. 26 is a perspective illustration of the guide rail illustrated in FIG. 25, showing the engagement of a locking member to hold the two parts of the guide rail in close proximity to one another;

FIG. 27 is an enlarged perspective view of the guide rail and locking member illustrated in FIG. 26;

FIG. 28 is a further enlarged perspective view of the guide rail and locking member shown in FIG. 27;

FIG. 29 is a perspective, end view of the embodiment of the cutting guide illustrated in FIG. 24;

FIG. 30 is a perspective, rear view of the vinyl siding support illustrated in FIG. 29;

FIG. 31 is an end view of the guide rail illustrated in FIG. 24, providing a detailed view of the ramp associated therewith;

FIG. 32 is a front, perspective illustration of an angular measuring indicator (or protractor) that is employed in connection with the various embodiments of the present invention;

FIG. 33 is a rear, perspective illustration of the angular measuring indicator illustrated in FIG. 32;

FIG. 34 is a perspective, front illustration of a further embodiment of the cutting guide of the present invention;

FIG. 35 is a perspective, rear illustration of the embodiment of the cutting guide of the present invention shown in FIG. 34;

FIG. 36 is an enlarged, perspective illustration of the front and rear legs for the cutting guide illustrated in FIG. 34, show in an unlocked position;

FIG. 37 is an enlarged, perspective illustration of one contemplated construction for the cutting guide and front and rear legs, as shown in FIG. 36;

FIG. 38 is an enlarged, perspective illustration of the connection between the guide rail and the legs for the cutting guide illustrated in FIG. 34;

FIG. 39 is a perspective, side view of one of the supports for the cutting guide illustrated in FIG. 34, showing the legs in a locked position;

FIG. 40 is a perspective illustration of the support shown in FIG. 39, with the legs being shown in an unlocked position;

FIG. 41 is a side view of the embodiment of the cutting guide shown in FIG. 34;

FIG. 42 is an enlarged, perspective view of a clamping member provided on the embodiment of the cutting guide show in FIG. 34;

FIG. 43 is an enlarged, perspective view of the clamping member illustrated in FIG. 42;

FIG. 44 is an enlarged, perspective illustration of a pointer device associated with the second embodiment of the cutting guide of the present invention as illustrated in FIG. 34;

FIG. 45 is an end view of the pointer device shown in FIG. 44;

FIG. 46 is a perspective illustration of another embodiment of the cutting guide of the present invention;

FIG. 47 is a perspective illustration of the embodiment illustrated in FIG. 46, the perspective being taken from a different angle;

FIG. 48 is a perspective illustration of an aspect of the embodiment of the present invention that is illustrated in FIG. 46;

FIG. 49 is a perspective illustration of a further aspect of the present invention, a dust removal apparatus that may be employed in connection with one or more of the embodiments of the cutting guide of the present invention;

FIG. 50 is another perspective illustration of the cutting guide of the present invention, which includes the dust removal apparatus shown in FIG. 49;

FIG. 51 is a perspective illustration of a variation on the dust removal apparatus illustrated in FIG. 49;

FIG. 52 is a perspective, expanded illustration of a coupling contemplated to connect to the cutting guide of the present invention, the coupling being a portion of the dust removal apparatus;

FIG. 53 is a perspective illustration of the coupling shown in FIG. 52;

FIG. 54 is a perspective illustration of a portion of the dust removal apparatus shown in FIG. 51;

FIG. 55 is a perspective illustration of a calibration mechanism contemplated for use with the cutting guide of the present invention; and

FIG. 56 is an enlarged, perspective view of the calibration mechanism shown in FIG. 55.

### DETAILED DESCRIPTION OF EMBODIMENT(S) OF THE INVENTION

The present invention will now be described in connection with one or more embodiments. Discussion of any particular embodiment is intended to be exemplary only. In other words, the embodiments described are intended to outline the breadth of the scope of the present invention. As should be apparent to those skilled in the art, there are numerous equivalents and variations that may be employed without departing from the scope of the present invention. Those equivalents and variations are intended to be encompassed by the present invention.

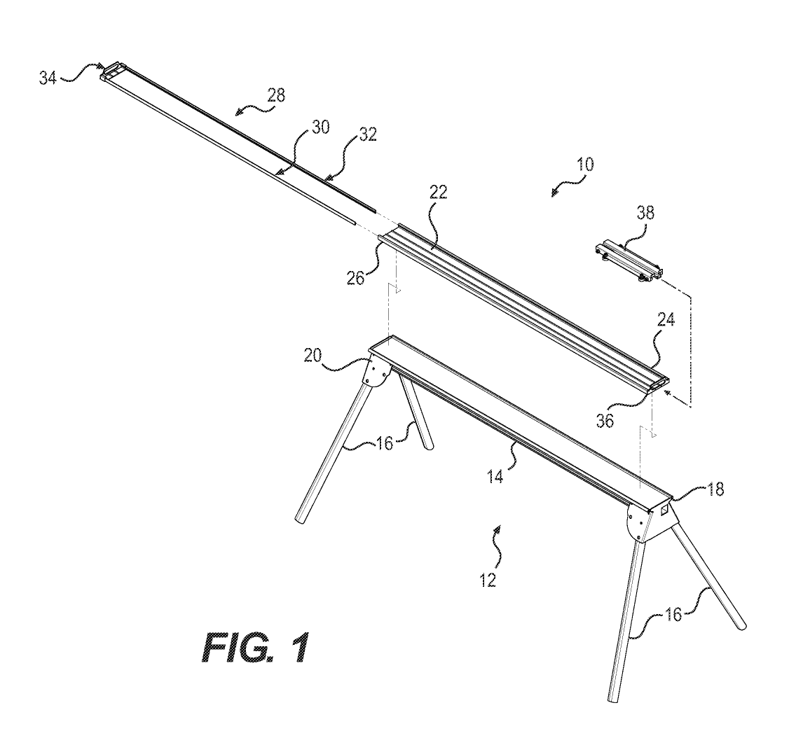

FIG. 1 is a perspective illustration of a first embodiment of a cutting guide 10 of the present invention. The cutting guide 10 includes four basic components. The first component is the work horse 12. The work horse 12 includes a central support surface 14 (also referred to herein as a “central rail”) supported by four legs 16. The legs 16 are contemplated to be hingedly attached at the first end 18 and the second end 20 of the central support 14. Being hingedly mounted, the legs 16 may be folded against the central support 14 to present a compact construction for storage and transport of the cutting guide 10.

A guide rail 22 is supported on the surface of the central support 14. The guide rail 22 has a first end 24 and a second end 26 consistent with the first and second ends 18, 20 of the work horse 12. The guide rail 22 is contemplated to be hingedly mounted at its first end 24 to the first end 18 of the work horse 12. As should be apparent from the discussion that follows, however, the guide rail 22 may be connected in any other fashion without departing from the scope of the present invention.

The guide rail 22 is constructed to receive an extension member 28. The extension member 28 includes a first leg 30 and a second leg 32. The first and second legs 30, 32 slide into grooves or channels within the guide rail 22. The extension member 28 includes an end cap 34 that connects the first and second legs 30, 32 to one another. A matching end cap 36 also may be provided at the first end 24 of the guide rail 22.

The guide rail 22 is intended to receive a carriage 38 therein or thereon. The carriage 38 supports a cutting device, which is not illustrated in FIG. 1. For purposes of the present invention, it is contemplated that the cutting device is a saw, such as a circular saw. However, the present invention is not intended to be limited to a circular saw. To the contrary, the present invention is contemplated to accommodate any suitable type of cutting and/or shaping tool including, but not limited to, a saw, a circular saw, a band saw, a jig saw, and a router. There are numerous types of cutting and/or shaping tools that may be employed with the present invention without deviating from the scope of the present invention. Since a saw is contemplated to be the primary type of cutting device employed in connection with the present invention, the term “saw” may be used in the discussion of the present invention. Use of the term “saw” should not be understood to be limiting of the present invention.

It is noted that the carriage 38 is likely to be attached to the underside of the cutting device rather than permanently being disposed within the guide rail 22. In this regard, it is understood that the end cap 36 will be removable so that the carriage 38, with the attached cutting device, may be slid into the first end 24 of the guide rail 22.

Alternatively, the carriage 38 may be configured to fit within the guide rail 22 by some other mechanism other than removal of the end cap 36. The present invention, therefore, is not intended to be limited by any construction of the carriage 38 that limits the manner in which the carriage 38 is inserted into the guide rail 22.

As should be apparent from FIG. 1, the extension 28 is intended to be approximately the same length as the guide rail 22. When the extension 28 is extended from within the guide rail 22, the carriage 38 is intended to be able to travel the fill length of the guide rail 22 plus the extension 28. In other words, it is contemplated that the carriage 38 will travel between the end caps 34, 36, regardless of the extended condition of the extension 28.

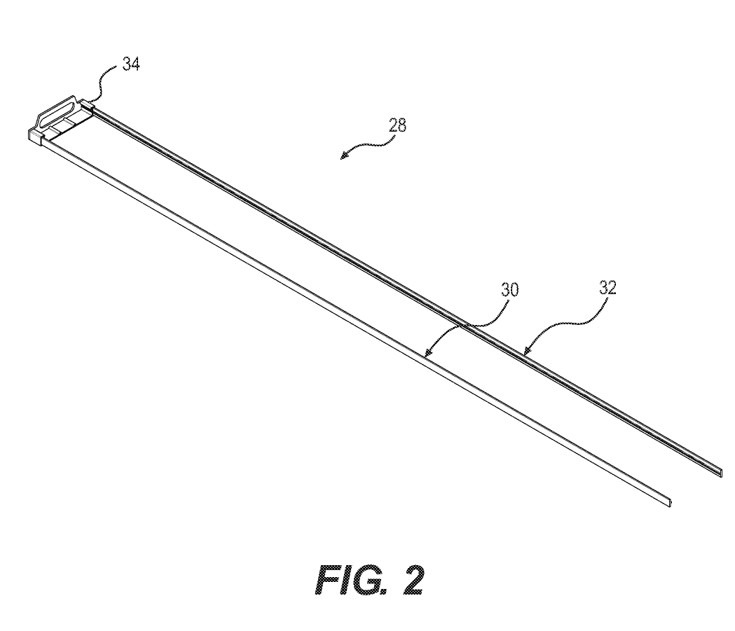

Before turning to FIG. 2, it is noted that the components of the cutting guide 10 are intended to be made from a light weight but strong material. Aluminum and aluminum alloys are contemplated as construction materials for the components of the cutting guide 10. Naturally, aluminum and its alloys are not the only materials that may be used. To the contrary, it is contemplated that the cutting guide 10 may be made from other metals, plastics, fiberglass, composite materials, nylon, or any combination thereof. White not intended to be limiting of the invention, alternative metals include steels, iron, iron alloys, titanium, titanium alloys, magnesium, magnesium alloys, beryllium, beryllium alloys, and the like. Composite materials include, but are not limited to materials that include carbon fiber, aramid fibers (such as Kevlar®), and the like. Other materials also may be employed without departing from the scope of the present invention.

FIG. 2 is an enlarged, perspective of the extension 28 illustrate in FIG. 1. In this illustration, it is apparent that the extension 28 is a U-shaped member. Here the first and second legs 30, 32 are more clearly illustrated. As shown, the legs 30, 32 are essentially rectangular in cross-section. While a rectangular cross-section is contemplated for the legs 30, 32, the legs 30, 32 may have cross-sections with any suitable shape without departing from the scope of the present invention.

The end cap 34 is contemplated to be fixed to the two legs 30, 32. The end cap 34 may have a handle 40 fashioned therein. Other contemplated embodiments exclude a handle 40.

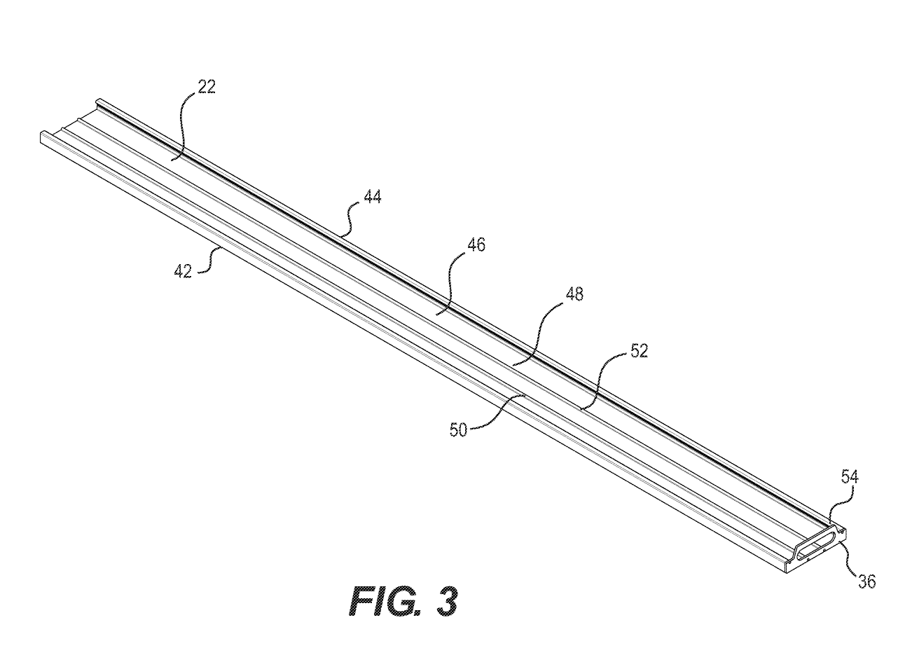

FIG. 3 is an enlarged, perspective illustration of the guide rail 22 illustrated in FIG. 1. The guide rail includes first and second sides 42, 44 that extend upwardly from a base 46. On the top surface 48 of the base 46, two ridges 50, 52 extend the length of the guide rail 22. The ridges 50, 52 provide additional strength to the guide rail 22 and also may provide additional guidance for the carriage 38. As noted above, the guide rail 22 may include an end cap 36. The end cap 36 may include a handle 54.

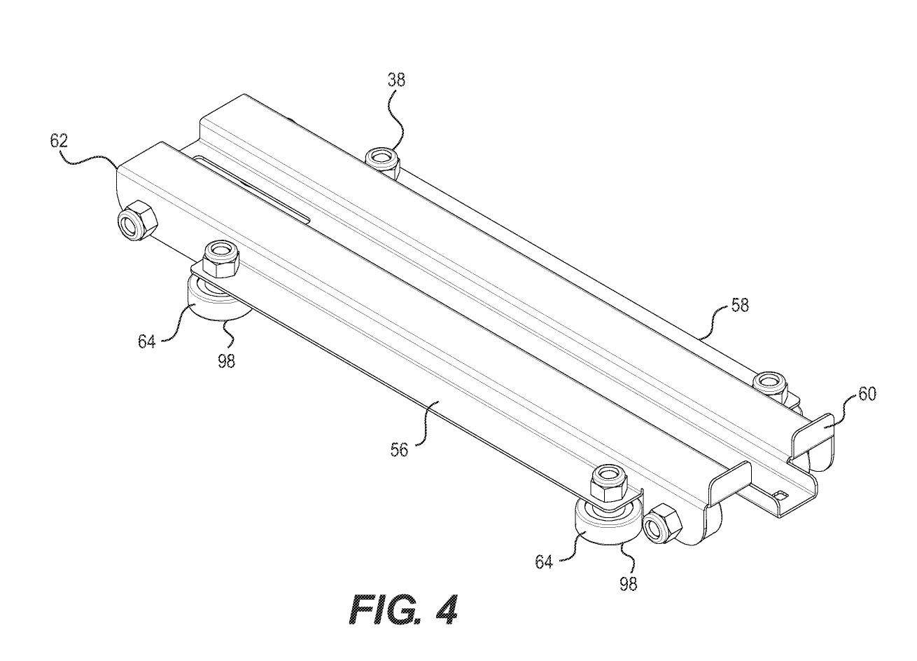

FIG. 4 is an enlarged, perspective illustration of the carriage 38 that is illustrated in FIG. 1. The carriage 38 is contemplated to be made from aluminum or an alloy of aluminum, as discussed above. The carriage 38 includes first and second sides 56, 58 and front and rear ends 60, 62. So that the carriage 38 may travel within the guide rail 22, several wheels 64 disposed thereon. While wheels 64 are employed in the illustrated embodiment, it is understood that means other than wheels 64 may be employed without departing from the scope of the present invention. For example, the carriage may include sliding elements made from (or coated with) polytetrafluoroethylene or a suitable alternative material.

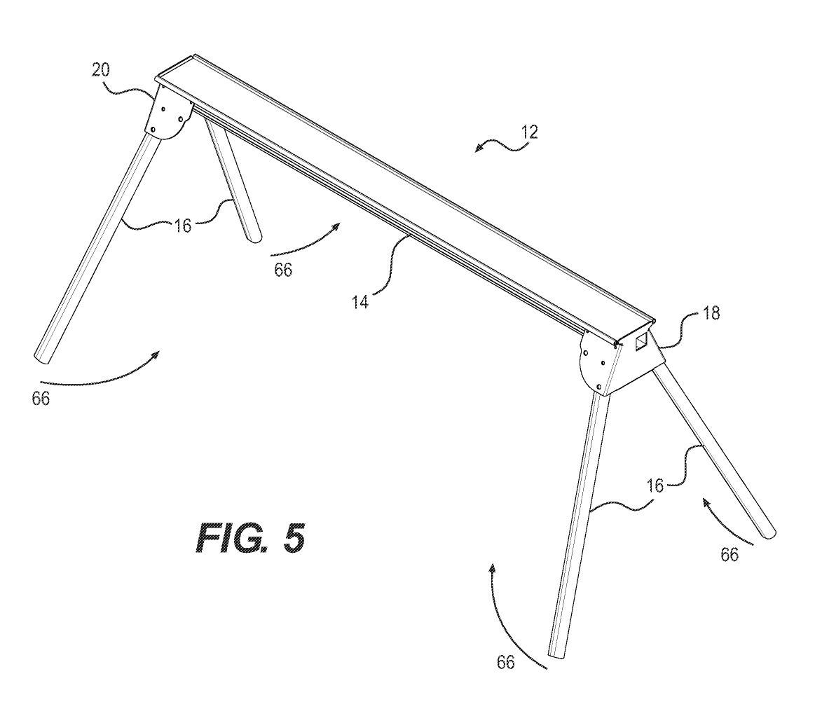

FIG. 5 is an enlarged, perspective illustration of the work horse 12 that is illustrated in FIG. 1. As discussed above, the legs 16 are contemplated to fold against the central support 14 so that the work horse 12 may be folded into a compact arrangement for easy storage and transportation. Arrows 66 are provided to indicate the direction in which the legs 16 may be folded.

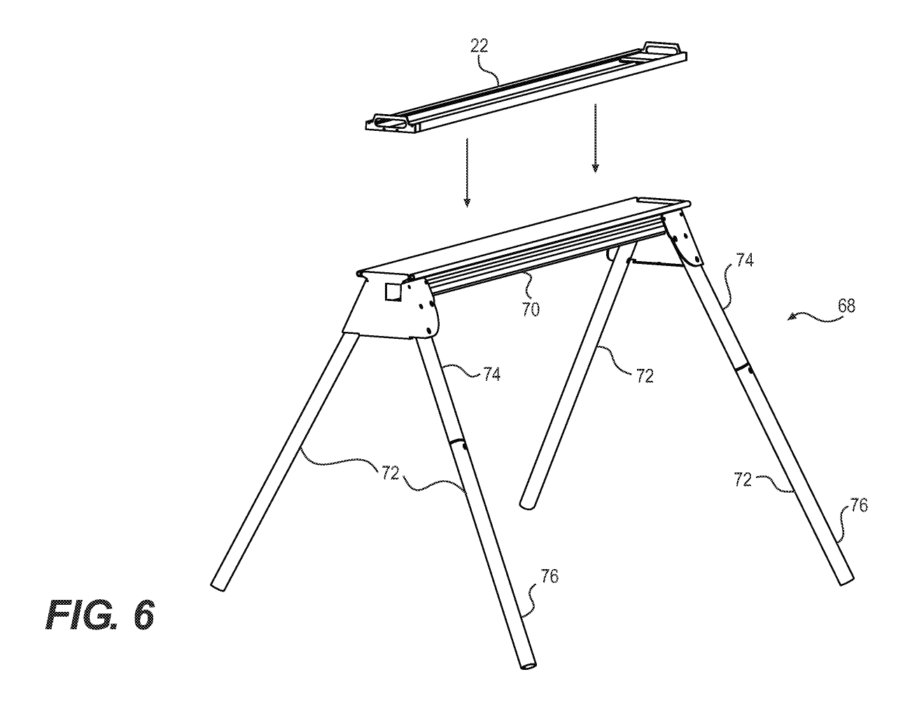

FIG. 6 is an illustration of another type of work horse 68 that is contemplated for the cutting guide of the present invention. In this embodiment, the work horse 68 includes a central support 70 supported by four legs 72. Two of the legs 72 in this embodiment are contemplated to be separable into two parts 74, 76. As may be appreciated from the illustration, the bottom part 76 of the legs 72 may be separated from the top part 74 of the legs. The guide rail 22 is illustrated as well.

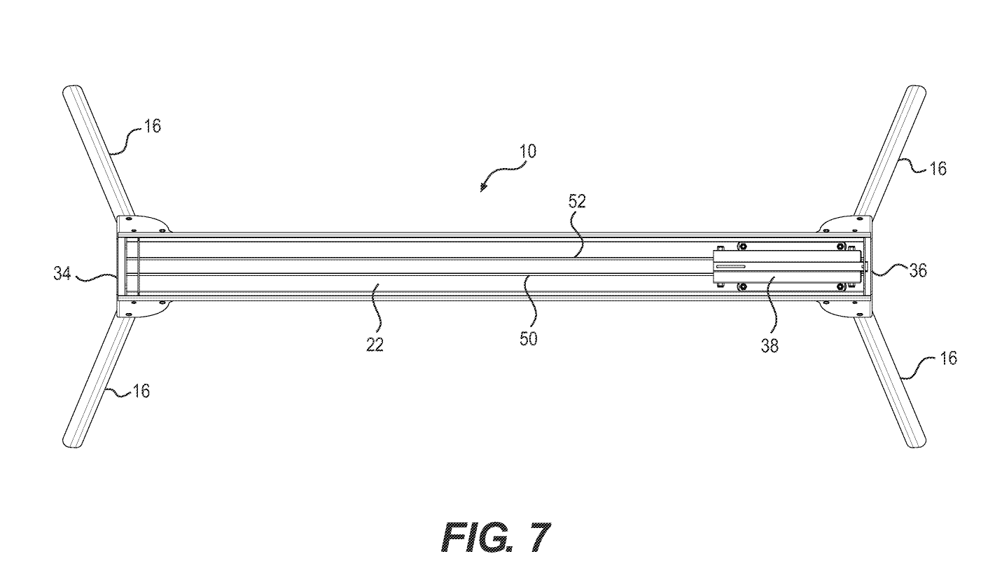

FIG. 7 is a top view of the embodiment of the cutting guide 10 that is illustrated in FIG. 1. Details of the guide rail 22 and the carriage 38 are visible in this illustration, including the ridges 50, 52.

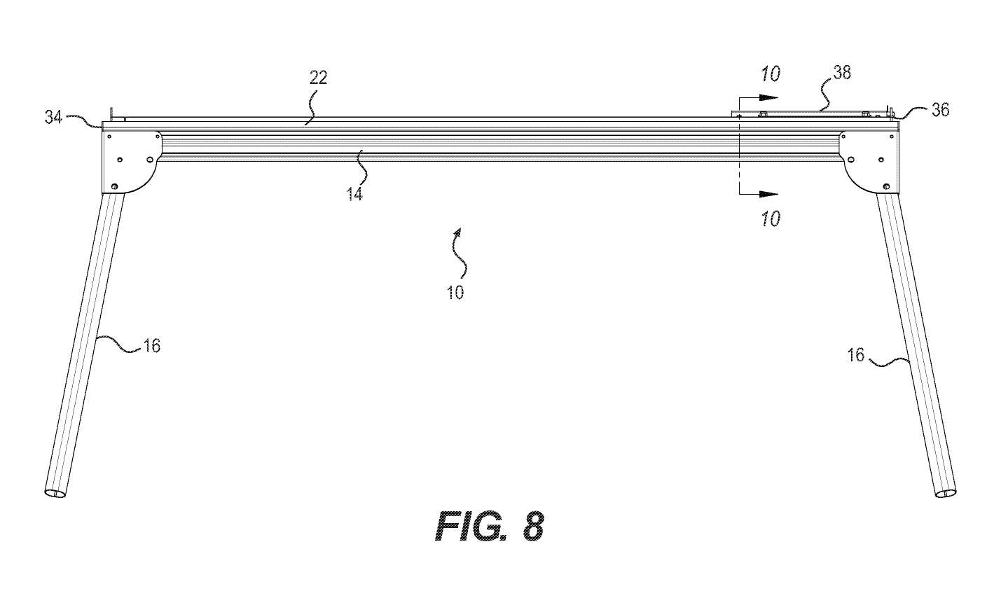

FIG. 8 is a side view illustration of the cutting guide 10 that is illustrated in FIG. 1. Among other features, the top surface of the carriage 38 is visible at the right hand side of the illustration.

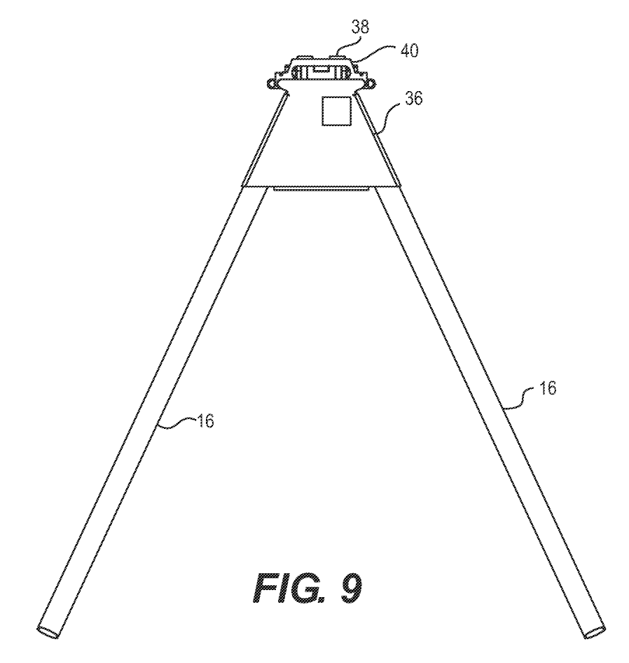

FIG. 9 is an end view of the cutting guide 10 illustrated in FIG. 1. The handle 40 is clearly visible in this illustration as is part of the carriage 38. The handle 40 is contemplated to be an optional feature and, therefore, is not required to practice the present invention.

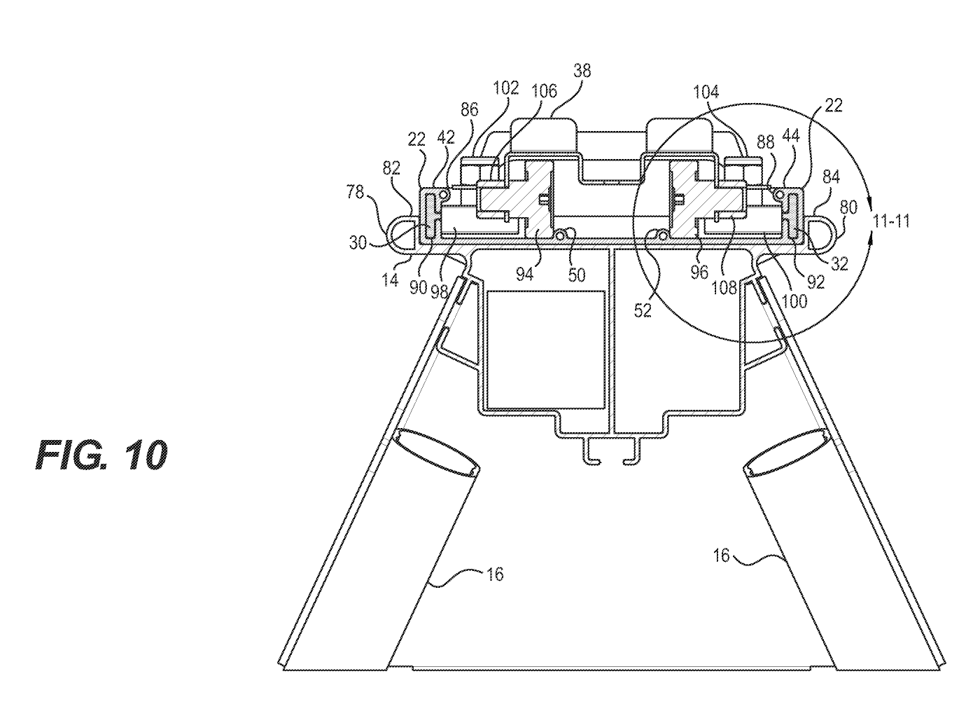

FIG. 10 is a cross-section of the cutting guide 10, taken along the line 10-10 in FIG. 8. Details of the construction of the central support 14, the guide rail 22, and the carriage 38 are visible in this illustration. Portions of the legs 16 also are depicted.

As is apparent in FIG. 10, the legs 16 are hollow tubes with oval cross-sections. As should be appreciated by those skilled in the art the legs 16 need not be oval in cross-section. Any other suitable shape may be employed without departing from the scope of the present invention. Moreover, while the legs 16 are illustrated with a hollow construction, the legs may be made as a solid piece of material without departing from the scope of the present invention.

The central support 14 includes a first side 78 and a second side 80. The first and second sides 78, 80 include raised edges 82, 84 that are adapted to receive the guide rail 22. The guide rail 22 has first and second sides 42, 44, as described above. The first and second sides 42, 44 include lips 86, 88 that extend inwardly toward a center of the guide rail. The lips 86, 88 provide an upper edge on either side of the guide rail to help retain the carriage 38 therein.

The sides 42, 44 include hollow channels 90, 92 into which the legs 30, 32 slide when the extension 28 is in the retracted position. As illustrated in this embodiment, the legs 30, 32 have a T-shaped cross-section, which is anticipated to provide additional rigidity to the legs 30, 32, especially when the extension 28 is in the distended (or non-retracted) position. It is noted that the legs 30, 32 may have any suitable cross-section without departing from the scope of the present invention.

As is apparent in FIG. 10, the carriage 38 includes vertically-oriented wheels 94, 96 that engage the top surface 48 of the guide rail 22. Horizontally-oriented wheels 98, 100 also are provided on the carriage 38. The horizontally-oriented wheels 98, 100 are positioned to engage the sides 42, 44 of the guide rail 22. The horizontally-oriented wheels 98, 100 are retained within the guide rail 22 under the lips 86, 88.

As is apparent from FIG. 4, it is contemplated that the carriage 38 will incorporate two horizontally-oriented wheels 98 on one side and two horizontally-oriented wheels 100 on the opposite side. Similarly, it is contemplated that there will be two vertically-oriented wheels 94 on one side of the carriage 38 and two vertically-oriented wheels 96 on the other. While this number of wheels is contemplated for the illustrated embodiment, a larger or smaller number of wheels may be employed without departing from the scope of the present invention.

The wheels 94, 96, 98, 100 are contemplated to be made from rubber, plastic, or polytetrafluoroethylene (“PTFE”) and/or combinations thereof. Metals also may be employed without departing from the scope of the invention. It is contemplated that PTFE (otherwise known as Teflon®) may be a suitable material, since it is anticipated to facilitate movement of the carriage 38 within the guide rail 22. If the wheels 94, 96, 98, 100 are made from (or are coated with) PTFE, it is anticipated that the carriage 38 will enjoy a less restricted movement within with guide rail 22.

The wheels 98, 100 are retained on the carriage via bolts 102, 104. The wheels 94, 96 also are contemplated to be retained on the carriage 38 via bolts 106, 108. As should be apparent to those skilled in the art, the wheels 94, 96, 98, 100 may be affixed to the carriage 38 via any suitable means.

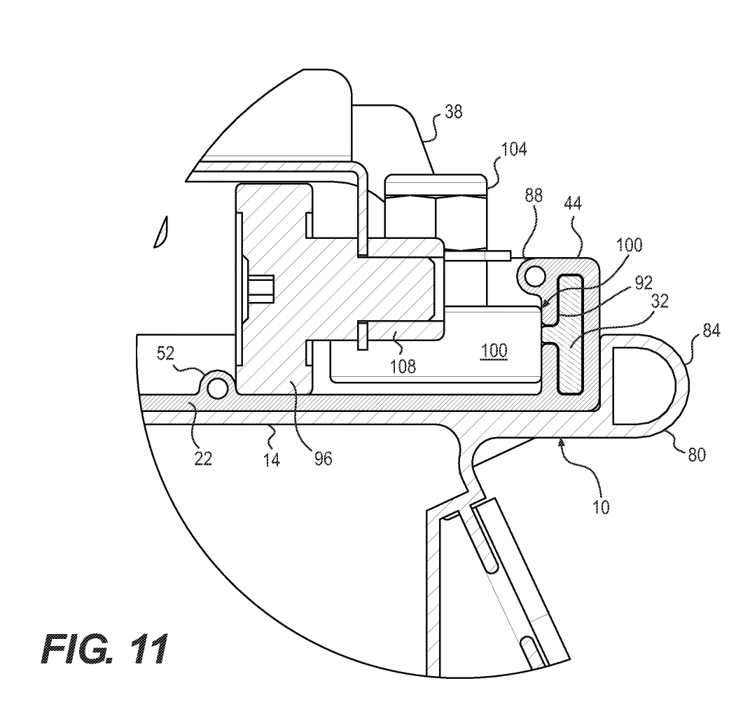

FIG. 11 is an enlarged, partial cross-section of the cutting guide 10, as illustrated in FIG. 10. Details of the central support 14, the guide rail 22, and the carriage 38 are visible in this illustration.

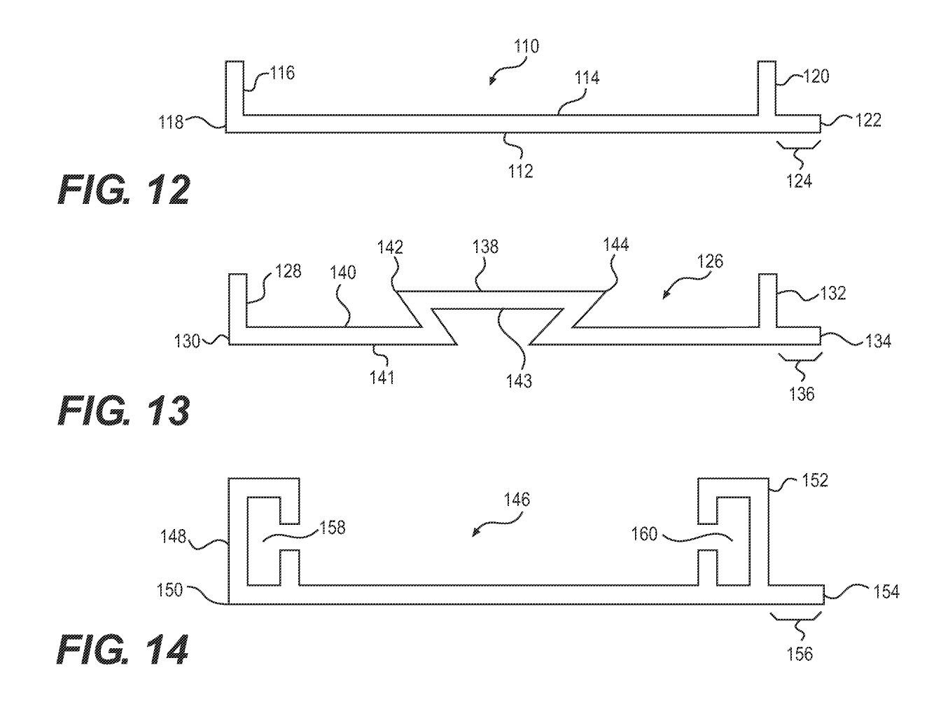

FIG. 12 is a cross-sectional end view of one alternative embodiment of a guide rail 110 contemplated for use with the present invention. This embodiment of the guide rail 110 is intended to be used in place of the guide rail 22 discussed above. The guide rail 110 includes a bottom surface 112 and a top surface 114. A first side 116 extends upwardly from a left edge 118 of the top surface 114. A second side 120 extends upwardly at a position inward from the right edge 122. The portion 124 of the guide rail 110 that extends exterior to the second side 120 is provided as a cutting guide 124 for the user of the present invention. Specifically, when the guide rail 22 is positioned against a material to be cut, the cutting guide 124 provide a visual indication of the location where the cutting tool (i.e., the circular saw blade) will cut the material. As a result, the cutting guide 124 assists the user to position the guide 110 for proper cutting of the construction material such as plywood or siding.

With respect to the embodiment of the guide rail 110 illustrated in FIG. 12, the sides 116, 120 exclude channels to receive the legs 30, 32 of an extension 28. This embodiment may be provided where an extension is not to be used with the cutting guide 10 of the present invention. Alternatively, the sides 116, 120 may be provided with channels, as discussed above.

FIG. 13 is a cross-sectional end view of another contemplated embodiment of a guide rail 126 for the present invention. In this embodiment, the guide rail 126 includes a first side 128 at the left edge 130 thereof. A second side 132 is positioned inwardly from the right edge 134 thereof. The position of the second side 132 defines a cutting guide 136, as in the prior embodiment.

In the embodiment of the guide rail 126 illustrated in FIG. 13, the central portion of the guide rail 126 includes a trapezoidal section 138 that extends upwardly from the top surface 140 of the guide rail 126. The trapezoidal section 138 may be incorporated into the guide rail 126 to provide additional rigidity and strength to the guide rail 126. It also may be provided to present two edges 142, 144. The carriage 38 may be modified to grip onto the edges 142, 144 and, thereby, to be retained within the guide rail 126.

FIG. 14 is an end view illustration of a third contemplated embodiment of a guide rail 146 for the cutting guide of the present invention. The guide rail 146 includes a left side 148 at the left edge 150 of the guide rail 146. A right side 152 extends upwardly at a position adjacent to the right edge 154 of the guide rail 146. The right side 152 defines a guide 156 as in the prior embodiments. In this embodiment, channels 158, 160 to receive the legs 30, 32 from an extension 28.

It is noted that the guide rails 110, 126, 146 are anticipated to be made from aluminum. Specifically, it is contemplated that the guide rails 110, 126, 146 will be aluminum that has been extruded in the shapes illustrated. As noted above, however, the guide rails 110, 126, 146 may be made from any other suitable material without departing from the scope of the present invention. In addition, while the guide rails 110, 126, 146 are contemplated to be extruded components, they do not need to be extruded components to practice the present invention. The guide rails 110, 126, 146 may be machined or fabricated according to any alternative methodology without departing from the scope of the present invention.

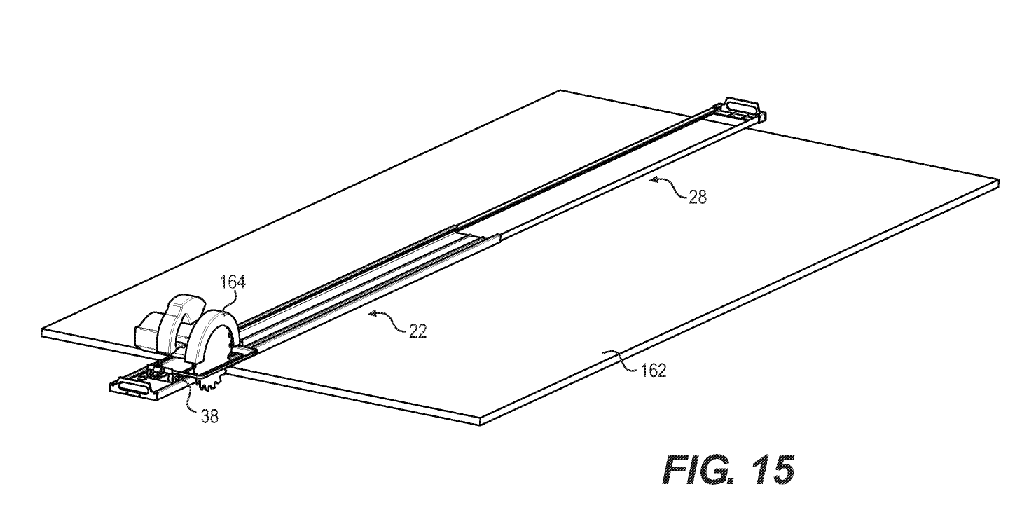

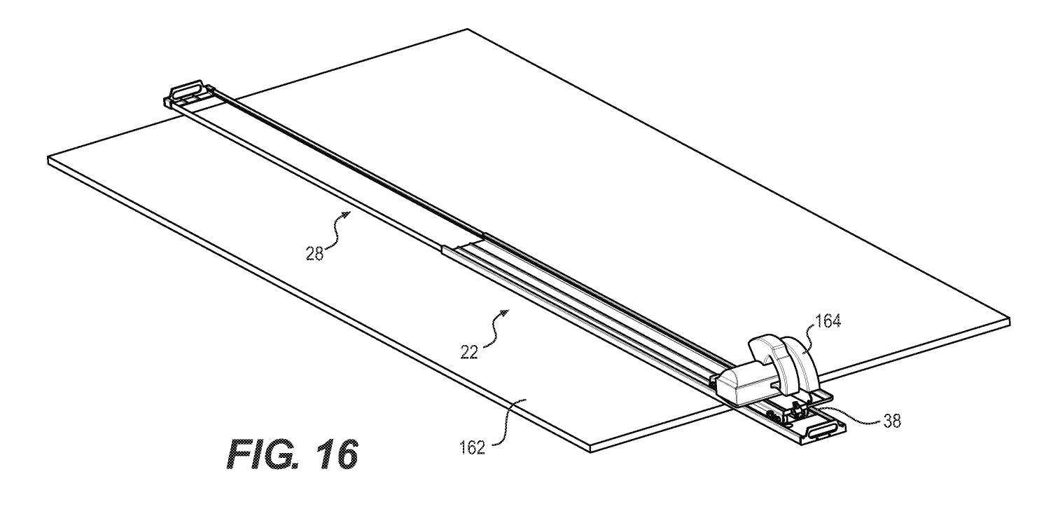

FIG. 15 is a perspective illustration of the use of the cutting guide 10 of the present invention. In this illustration, the guide rail 22 and the extension 28 have been laid onto a piece of plywood 162. A cutting device 164 (i.e., a circular saw) is attached to the carriage 38 so that the cutting device 164 is guided by the travel of the carriage 38 within the guide rail 22 and the extension 28.

With respect to the cutting device 164, it is contemplated that the cutting device 164 will be a circular saw. It is noted, as discussed above, that any other type of saw may be employed without departing from the scope of the present invention. In addition, the present invention should not be understood to be limited solely to saws. As noted above, it is contemplated that other tools may be substituted for the cutting device 164 without departing from the scope of the present invention.

FIG. 16 is a perspective illustration consistent with FIG. 15. In this illustration, the left side of the guide rail 22 and extension 28 are illustrated.

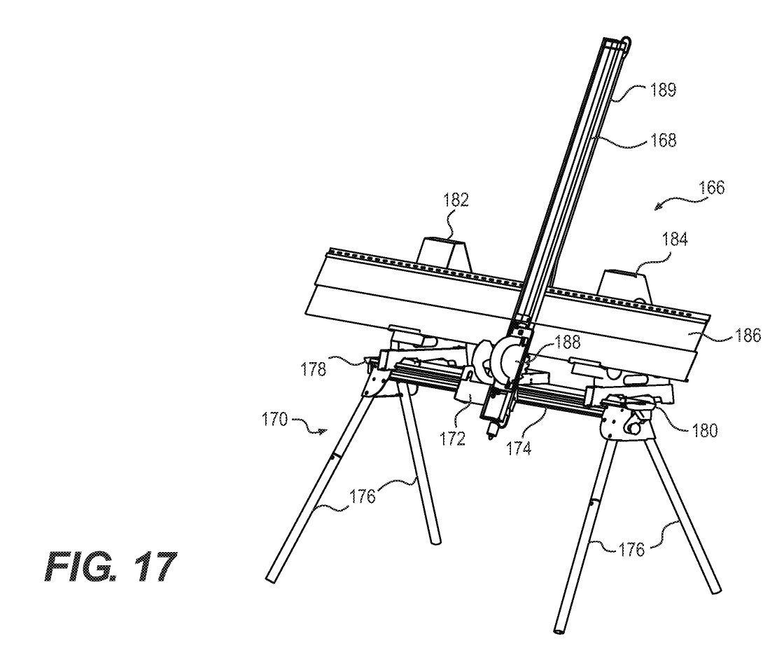

FIG. 17 is a perspective illustration of a cutting guide 166 according to another contemplated embodiment of the present invention.

As should be immediately apparent, the cutting guide 166 includes a guide rail 168 that is similar to the guide rail 22 described in connection with the cutting guide 10 in FIG. 1. In this embodiment, however, the guide rail 168 is not affixed to the top of the workhorse 170. Instead, the guide rail 22 has been affixed to a guide carriage 172 that travels along the central support 174 of the work horse 170.

The work horse 170 is largely the same as described in prior embodiments. The work horse 170 includes a central support 174 that is disposed atop four legs 176. At the first end 178 and the second end 180 of the workhorse 170, uprights 182, 184 are provided. The uprights 182, 184 receive a construction material 186 to be cut by the cutting device 188. In FIG. 17, the construction material 186 is siding for a home, for example.

In the illustrated embodiment, which is consistent with other embodiments of the present invention, the uprights 182, 184 are angled with respect to horizontal. Being oriented in this fashion, it is understood that any construction material 186 or substrate to be cut will be more easily secured, because gravity will assist in holding the substrate 186 in position.

In addition, to further hold the construction material or substrate 186 against the rear side of the guide rail 168, an elastic member 190 is affixed to the top of the guide rail 168. The elastic member 189 extends to the bottom of the guide rail 168. The elastic member 190 may be an elastic cord, a spring, or other material. The elastic member 189 cooperate with the force of gravity to exert sufficient pressure on the construction material 186 to hold the construction material 186 against the guide rail 168 while the construction material 186 is being cut by the cutting device 164, 188.

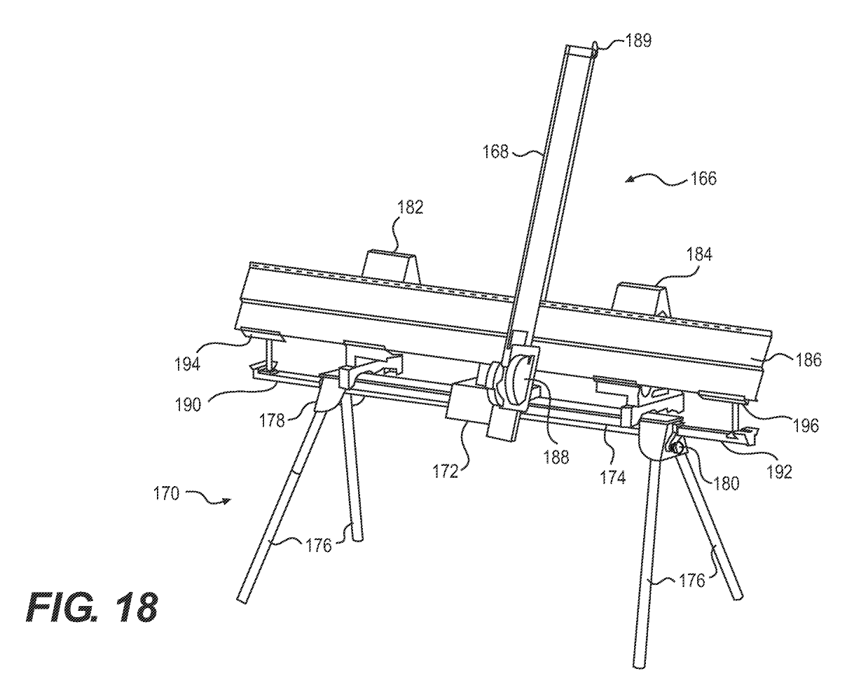

FIG. 18 is a perspective view of another aspect of the cutting guide 166 illustrated in FIG. 17. Since it is anticipated that the construction material 186 may be oversized (i.e., may be very long), the cutting guide 166 is provided with first and second extenders 190, 192. The first extender 190 extends from the first end 178 of the cutting guide 166. The second extender 192 extends from the second end 180 of the cutting guide 166. The first extender 190 includes a support arm 194. The second extender 192 includes a similar support arm 196.

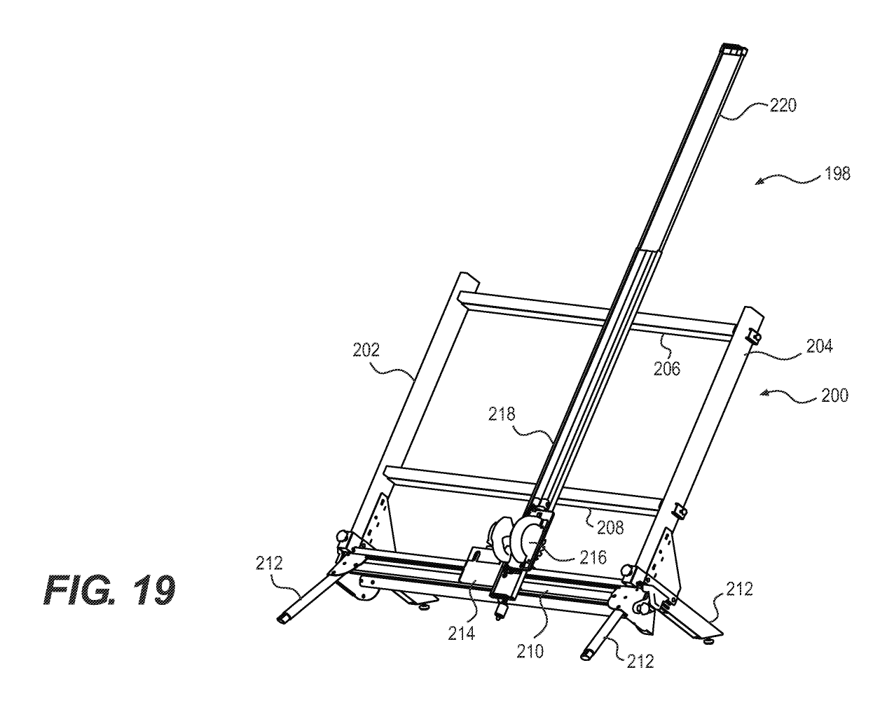

FIG. 19 is a perspective view of a cutting guide 198 according to another embodiment of the present invention. The cutting guide 198 is intended to cut large construction materials, such as plywood sheets.

As illustrated in FIG. 19, the cutting guide 198 includes a frame 200 with two uprights 202, 204. The uprights 202, 204 are connected by two horizontal bars 206, 208. The frame 200 is connected to a central support 210. The central support 210 is supported on four legs 212. A guide carriage 214 slidably engages the central support 210. The guide carriage 214 supports a cutting device 216 and a guide rail 218. As in prior embodiments, the guide rail 218 includes an extension 220.

It is contemplated that the uprights 202, 204 are adjustable with respect to the legs 212. Specifically, the uprights 202, 204 may be moved forwardly or rearwardly to accommodate different thicknesses of the substrate material to be cut.

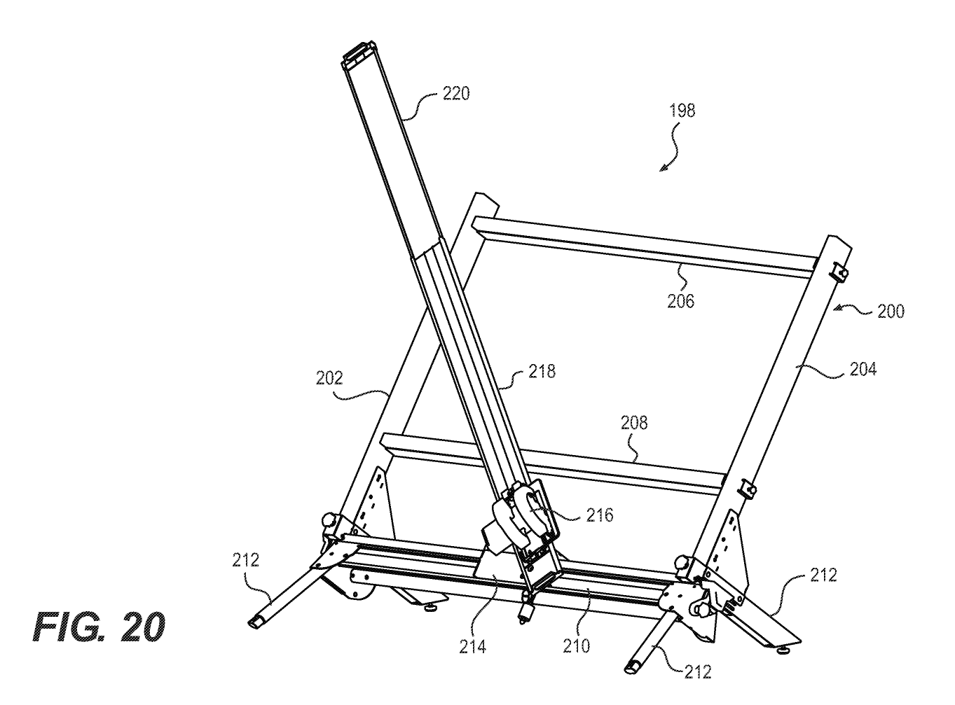

FIG. 20 illustrates the cutting guide 198 that is illustrated in FIG. 19. In this illustration, the guide rail 218 is shown in an angled position, which permits a user to cut the construction material at an angle.

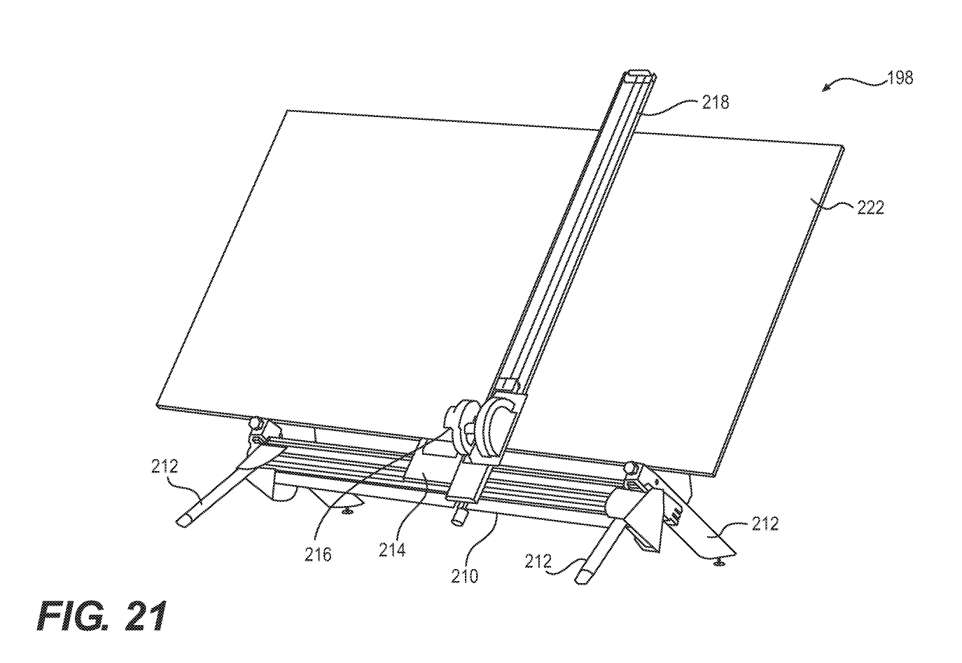

FIG. 21 is a perspective illustration of the cutting guide 198 illustrated in FIGS. 19 and 20. In this illustration, the construction material 222 is a piece of plywood. The guide rail 218 is oriented vertically in this illustration.

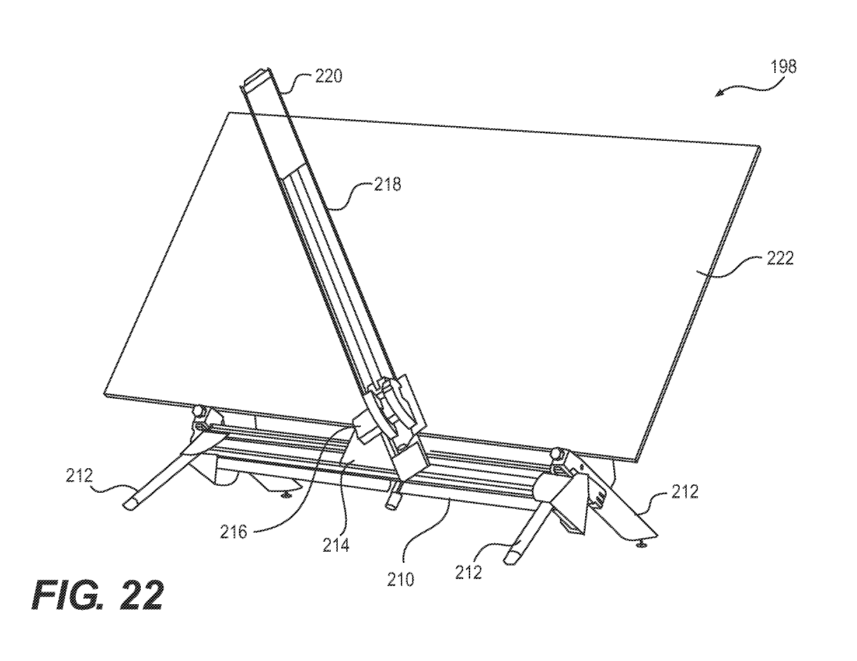

FIG. 22 is a perspective illustration of the cutting guide 198. In this illustration, the guide rail 218 is shown in an angled orientation. The extension 220 is shown in an extended position.

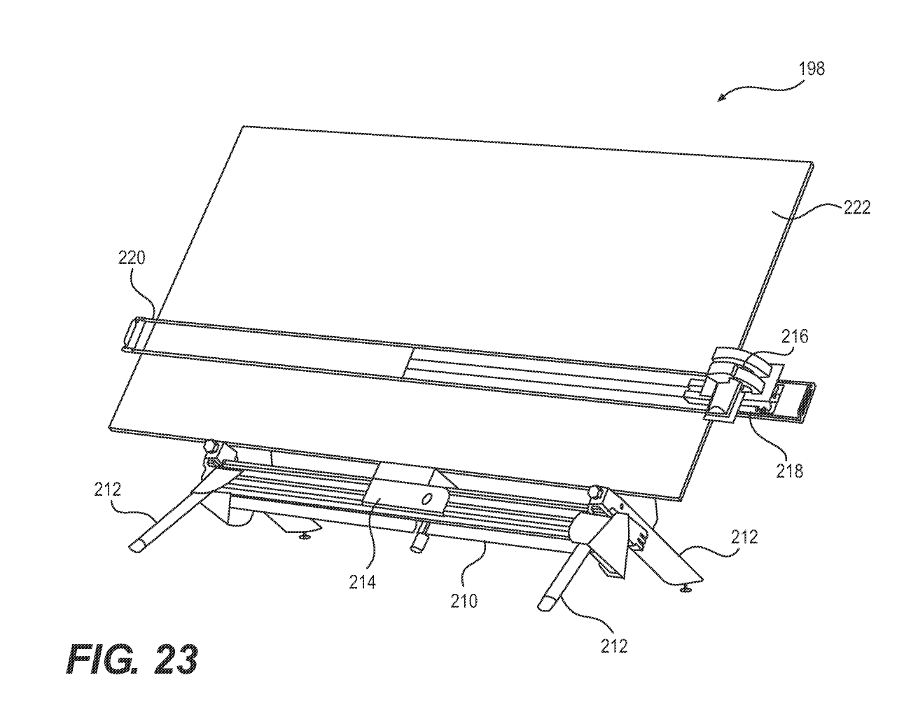

FIG. 23 is a perspective illustration of the cutting guide 198. In this embodiment, the guide rail 218 is oriented in a horizontal position to permit cutting of the construction material 222 along a length of the material.

With respect to the embodiments of the cutting guide 166 and 198 illustrated in FIGS. 17-23, it is noted that the devices are contemplated to hold the construction material 186, 222 at an angle with respect to the horizontal. Specifically, the angle is contemplated to be about 45°. This permits gravity to hold the construction material 186, 222 so that the construction material may be cut to appropriate dimensions and angles. The angle with respect to horizontal is contemplated to fall within a range of 40-50°, but may be as small as 15° or as large as 75° in other contemplated arrangements.

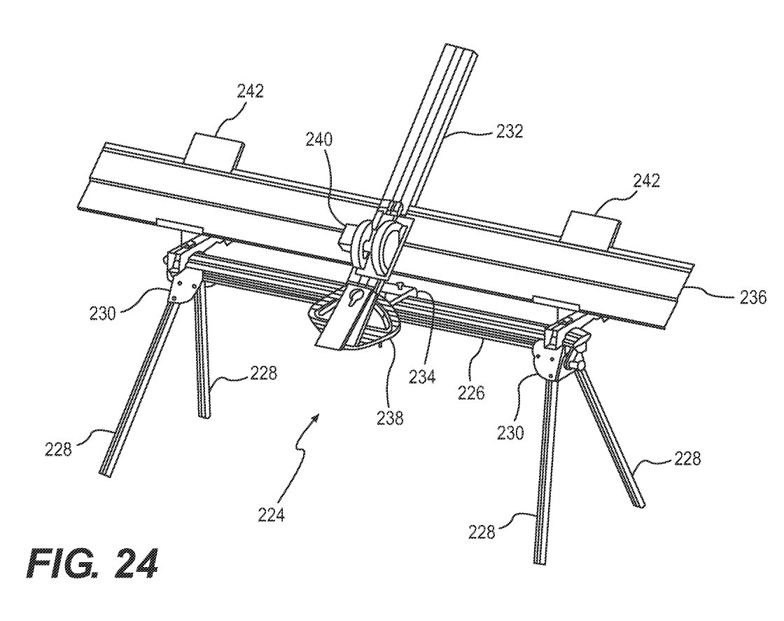

FIG. 24 provides a perspective view of still another embodiment of a cutting guide 224 according to the present invention.

Like the cutting guide 10 discussed above, the cutting guide 224 is essentially of the saw-horse type and includes a central rail or central support 226 supported by four legs 228. The legs 228 are connected to the central support 226 via brackets 230. A guide rail 232 is affixed to a carriage 234 that slides along the central rail 226 between the brackets 230. The guide rail 232 is mounted pivotally on the carriage 234 so that it may be angled with respect to the substrate 236 supported by the cutting guide 10. In this illustration, the substrate 236 is a piece of siding, such as vinyl siding.

As described in greater detail below, the guide rail 232 is connected to the carriage 234 via an angular measuring device or protractor 238. The protractor 238 permits the user of the cutting guide 224 to angle the guide rail 232 at the appropriate angle with respect to the substrate 236. In this figure, a cutting device 240 is disposed on the guide rail 232.

Substrate supports 242 are provided at each end of the central rail 226. The substrate supports 242 provide vertical support for the substrate 236, as illustrated. As should be immediately apparent, this construction is similar to the cutting guide 166 illustrated in FIG. 17.

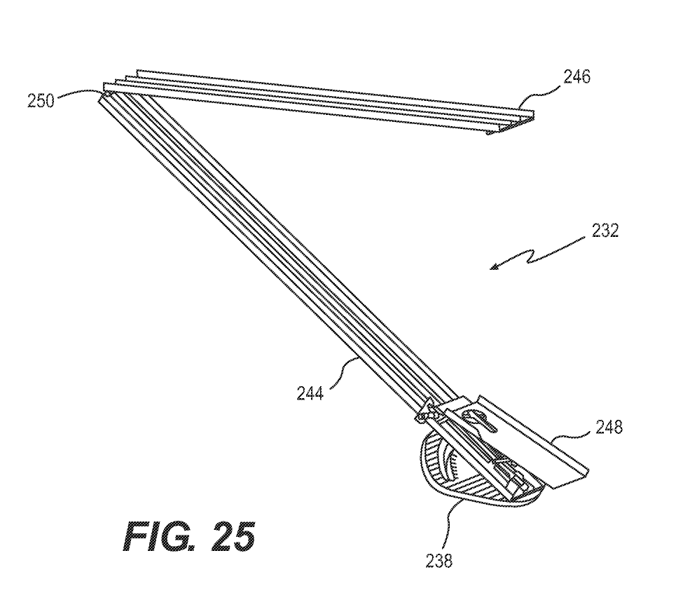

FIG. 25 provides a perspective illustration of the guide rail 232 and related components. As shown, the guide rail 232 includes a primary element 244 and a secondary element 246. The primary element 244 is rotatably affixed to the carriage 234 (not shown in this illustration) via the protractor 238. As also is visible in this illustration, a ramp 248 is connected to or disposed adjacent to the primary element 244. Among other functions, the ramp 248 facilitates access by the cutting device 240 to the primary element 244 and to the secondary element 246.

As illustrated in FIG. 25, the secondary element 246 is pivotally connected to the primary element 244 such that the secondary element 246 may overlay the primary element 244. In FIG. 25, the primary element 244 is connected to the secondary element 246 via a hinge 250 or other suitable connector. This arrangement is provided so that the substrate 236 may be sandwiched between the primary element 244 and the secondary element 246. This helps to secure the substrate 236 in position while the cutting device 240 is moved along the guide rail 232 to cut the substrate 236 at a suitable location and at a suitable angle, as desired.

In this embodiment of the cutting guide 224, cooperation between the primary element 244 and the secondary element 246 secures the substrate 236 while the cutting device 240 moves along the guide rail 232. As should be apparent, this embodiment replaces the elastic element 190, which is discussed in connection with the cutting guide 166 that is shown in FIG. 17, for example.

The primary element 244 and the secondary element 246 are shown in a partially opened position in FIG. 25. By contrast, the primary element 244 and the secondary element are shown in a closed position in FIG. 24.

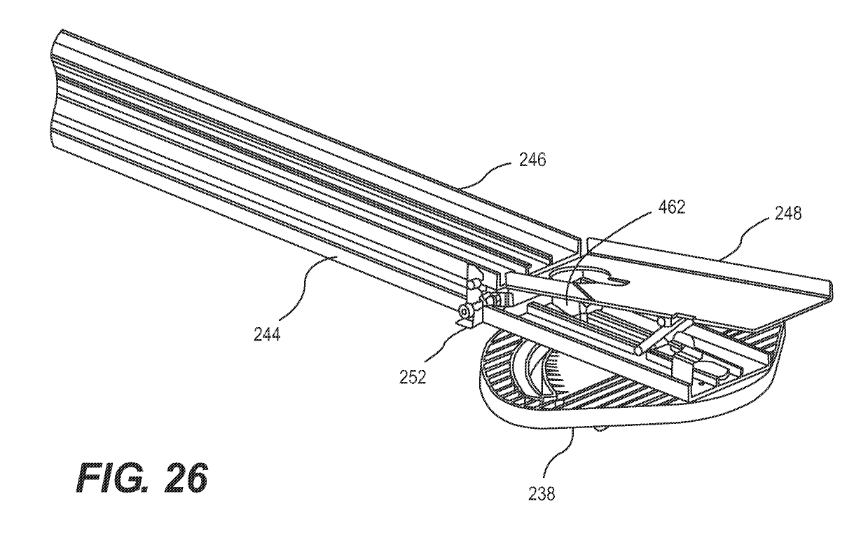

FIG. 26 illustrates the primary element 244 and the secondary element 246 in a closed position. In this closed position, to secure the secondary element 246 to the primary element 2440, a latch 252 is provided.

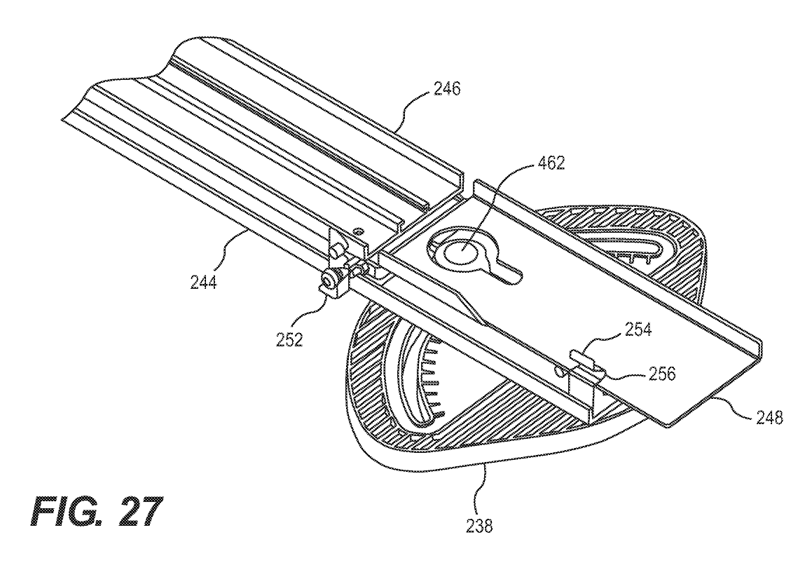

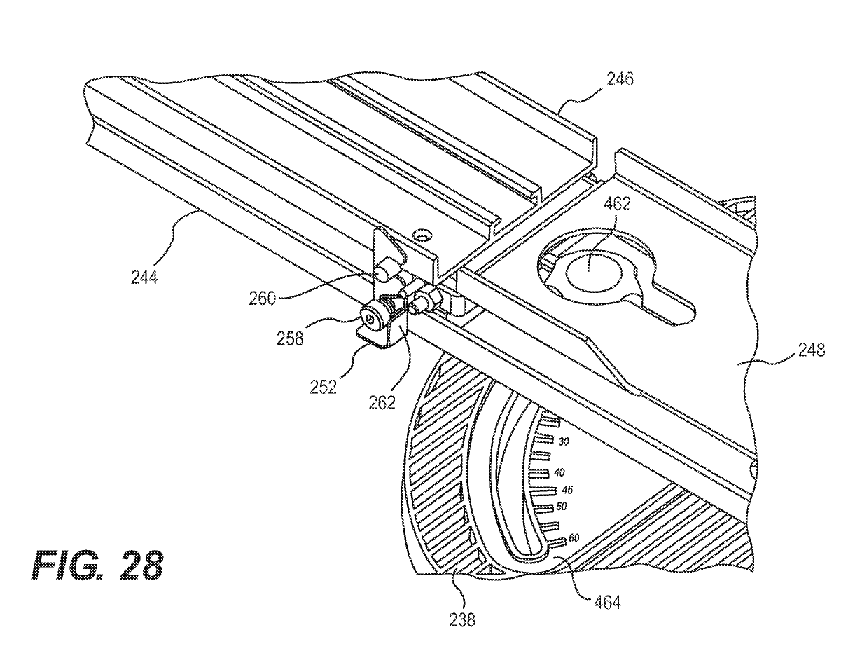

FIG. 27 is an enlarged view of a portion of the rail guide 232 illustrated in FIG. 26. The juxtaposition of FIGS. 26 and 27 illustrates the pivotal connection between the ramp 248 and the primary element 244. As shown in FIG. 26, the ramp 248 is angled so that it is not parallel to the plane of the primary element 244. In FIG. 27, the ramp 248 has been repositioned so that it is parallel to the plane of the primary element 244.

As may be appreciated in connection with FIG. 24, for example, when the guide rail 232 is positioned in relation to the substrate 236, the ramp 248 may be angled, as shown in FIG. 26, to facilitate introduction of the cutting device 240 onto the guide rail 232.

FIG. 27 also illustrates a retainer 254. The retainer 254 extends from and is connected to the primary element 244. The retainer 254 includes a protrusion 256 that extends inwardly from an exterior edge of the primary element 244. Since the retainer 254 is anticipated to be made from a metal material, such as aluminum, the retainer 254 is flexible and is able to be moved from its initial position to a position laterally adjacent to the sidewall of the primary element 244. When pushed outwardly, the retainer 254 releases the ramp 248 so that the ramp 248 may be adjusted to any suitable angular position with respect to the primary element 244. When the ramp 248 is returned to a position parallel to the primary element, the ramp 248 pushes the retainer 254 outwardly. After passing the protrusion 256, the retainer 254 returns to its initial position, as illustrated in FIG. 27, to secure the ramp 248 in its closed position. It is noted that, when the ramp 248 is not secured by the retainer 254, the ramp 248 is considered to be in a released or an opened position.

FIG. 28 is an enlarged perspective view of the latch 252 that secures the secondary element 246 to the primary element 244. The latch 252 is pivotally connected to the primary element 244 via a pivot 258. The other end of the latch 252 catches a protrusion 260 that is connected to the secondary element 246. In this manner, the secondary element 246 may be releasably secured to the primary element 244.

As should be apparent from FIG. 28, the top end of the latch 252 is shaped so that the protrusion 260 forces the latch 252 to open when the secondary element 246 is pressed against the primary element 244. In this way, the secondary element 246 may be easily secured to the primary element 244. In this embodiment, the latch 252 is understood to be secured to the primary element 244 via a biasing element, such as a spring 262. While a spring 262 is illustrated, any alternative biasing element may be employed without departing from the scope of the present invention.

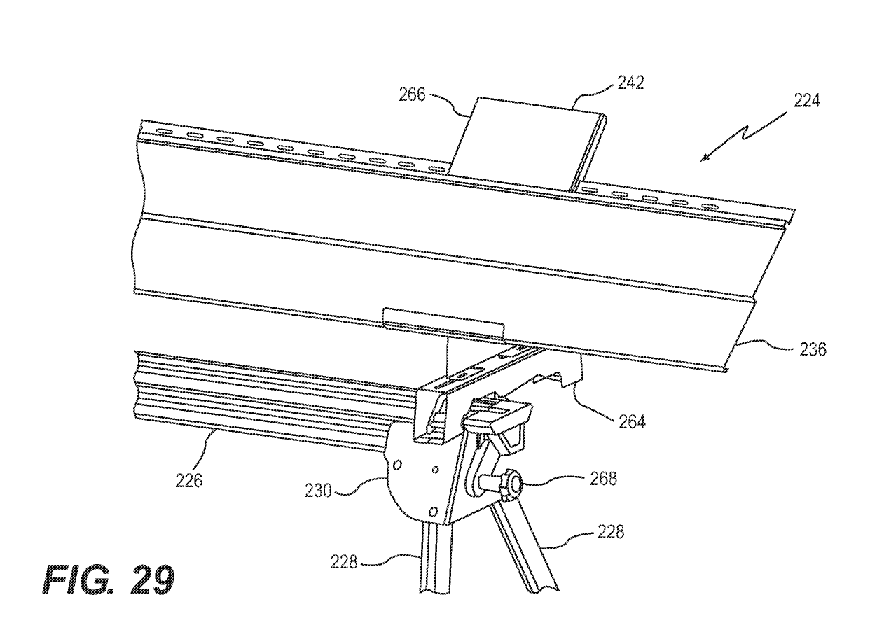

FIG. 29 is a perspective illustration that provides a detail of one end of the cutting guide 224 that is the subject of the present patent application. As illustrated, the substrate supports 242 include at least two parts: a rail engaging portion 264 and a substrate engaging portion 266. The substrate engaging portion 266 is connected to the rail engaging portion 264 so that the two parts move as a single unit. The substrate support 242 is positioned on the central rail 226 so that the substrate support 242 may move along the central rail 226 to any position suitable for supporting any length of substrate 236 placed thereon.

As also shown in FIG. 29, a crank 268 is provided on the central rail 226. The crank 268 may be positioned to move the substrate supports 242. Specifically, by rotating the crank 268, the substrate supports 242 may be moved along the central rail 226 to suitable positions therealong. Alternatively, the crank 268 may be employed to move the carriage 234 at any suitable position along the central rail 226. Still further, the crank 268 (or multiple cranks 268) may be provided to move the substrate supports 242 and the carriage 234 independently of one another. As should be apparent, the crank 268 is not required to practice the present invention.

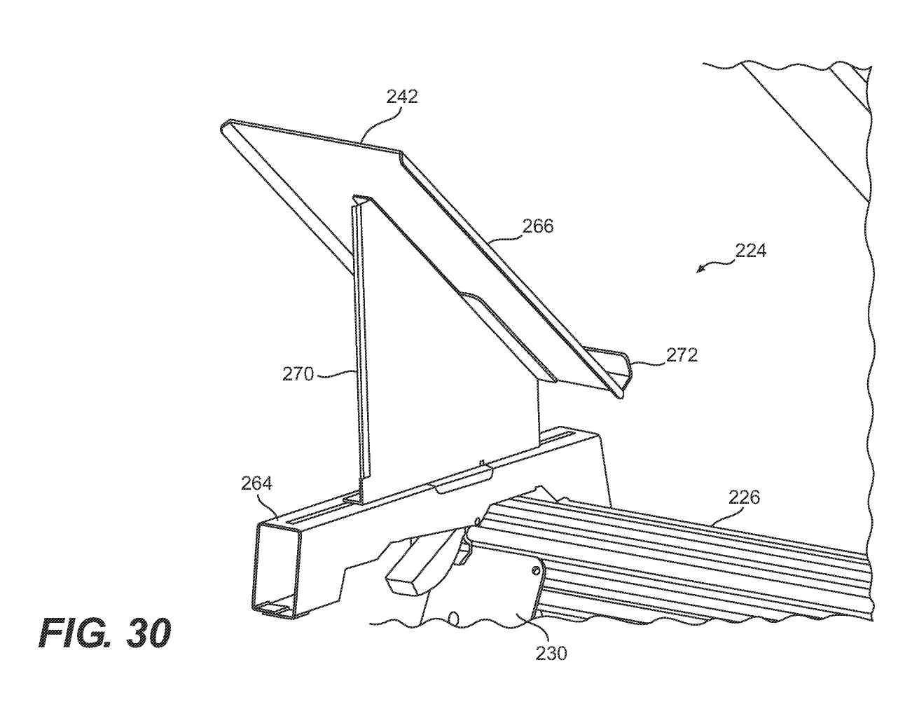

FIG. 30 is a perspective, rear view of one of the substrate supports 242, showing one contemplated construction thereof. In this illustration, a vertical support 270 connects the substrate supporting portion 266 to the rail engaging portion 264. It is noted that the substrate engaging portion 266 includes a lip 272 to assist with securement of the substrate 236 in the substrate supports 242.

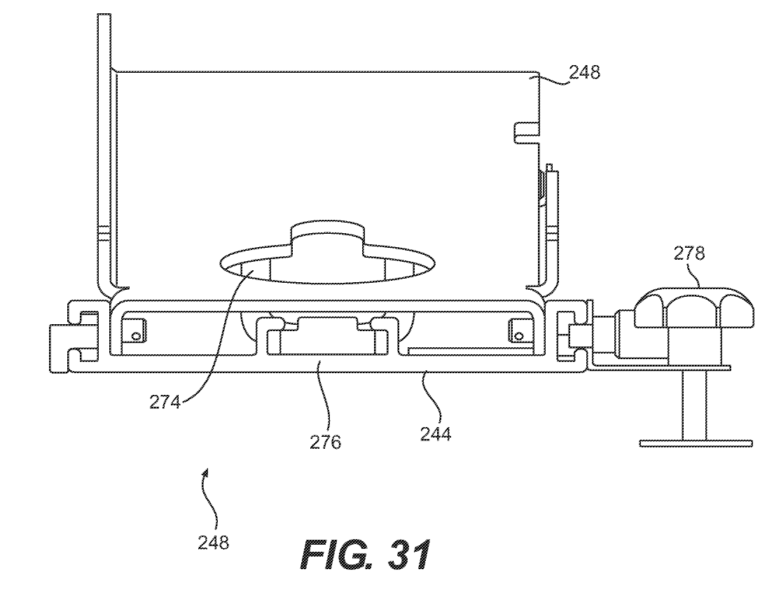

FIG. 31 provides an end view of the ramp 248 and its associated structural components. As shown in this illustration, the ramp 248 is supported by a U-shaped bracket 274 that slidingly engages a groove 276 in the center of the primary element 244. A clamping knob 278 is provided to fix the ramp 248 at a selected angular displacement. The clamping knob 278 also may function in connection with the protractor 238 to secure the guide rail 232 in relation to the substrate 236.

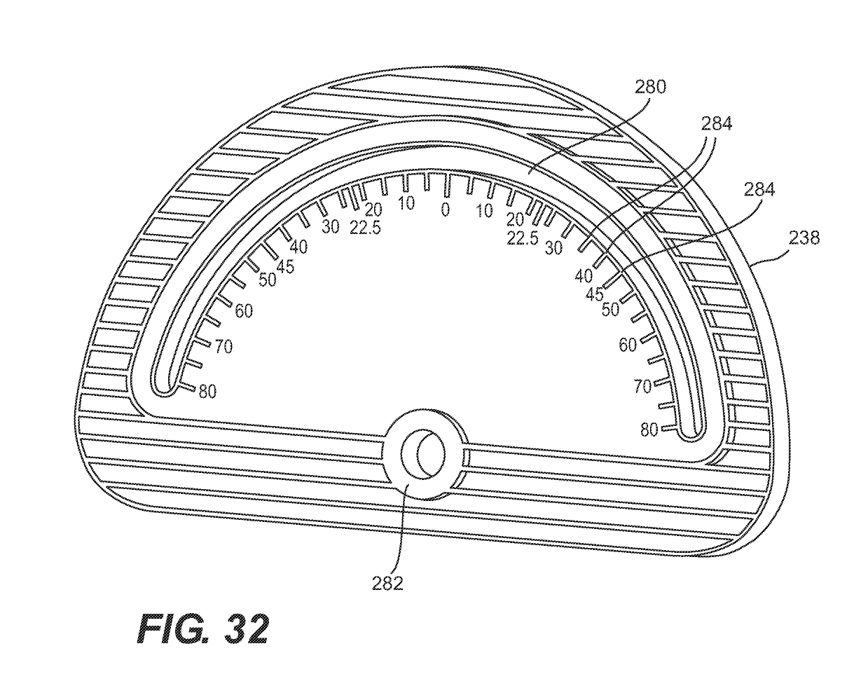

FIG. 32 illustrates a front view of the protractor 238. The protractor 238 includes a slot 280 into which the clamping knob 278 fits to secure the guide rail 232 at a suitable angular displacement with respect to the substrate 236. The protractor 238 also includes a central hole 282, which permits the protractor 238 to be secured in a suitable arrangement with respect to the primary element 244. The protractor 238 also includes indicia 284 to assist with fixing the clamping knob 278 at a suitable angle. The indicia 284 are anticipated to be provided, at regular intervals, along a 180° arc, as shown. As should be apparent, a larger or smaller arc may be employed without departing from the scope of the present invention.

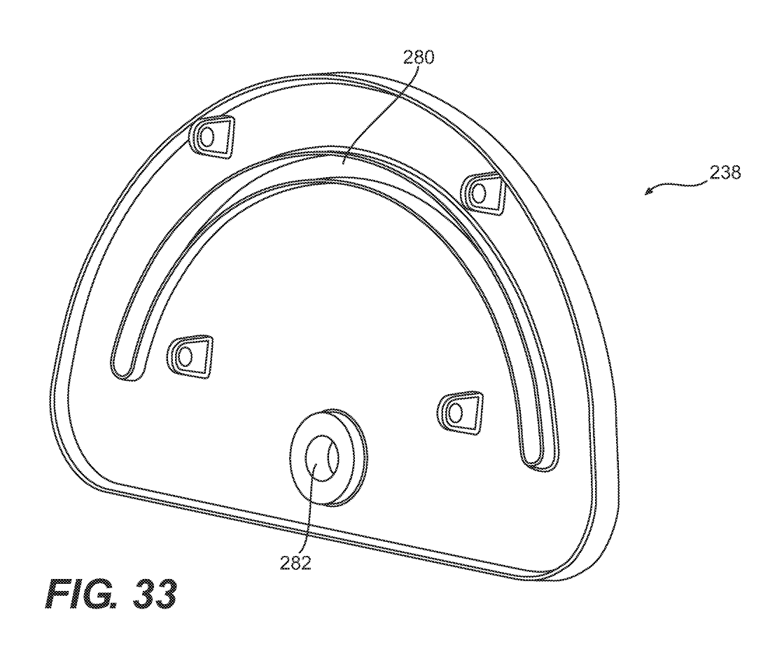

FIG. 33 is a rear view of the protractor 238, which is provided for purposes of illustration.

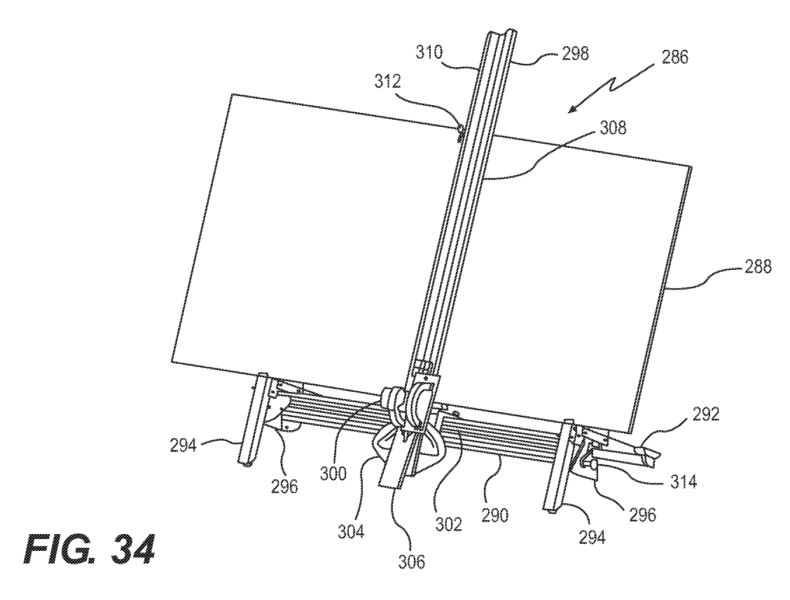

FIG. 34 is a perspective illustration of an additional embodiment of the cutting guide 286 of the present invention. This embodiment of the cutting guide 286 is designed to facilitate cutting of over-sized items, such as sheets of plywood. The substrate 288 illustrated in FIG. 34 is intended to represent a sheet of plywood. As should be apparent to those skilled in the art, however, the cutting guide 286 may be used to cut any other substrate 288, as desired or required.

This embodiment of the cutting guide 286 of the present invention shares many features of the cutting guide 198 that is illustrated in FIG. 19. For example, the cutting guide 286 includes a central rail 290 with legs 292, 294 at either end. The legs 292, 294 are connected to the central rail 290. Brackets 296 are provided at either end of the central rail 290. The front legs 294 are pivotally connected to the rear legs 292 in a manner discussed in greater detail below.

The cutting guide 286 includes a guide rail 298, which is positioned in front of the substrate 288. The guide rail 298 guides a cutting device 300 positioned thereon. The guide rail 298 is attached to a carriage 302 that slides along the central rail 290. The carriage 302 includes a protractor 304 and a ramp 306. It is contemplated that the construction of the guide rail 298 is similar to the construction discussion in connection with the guide rail 232, described above.

In the case where the guide rail 298 is positioned adjacent to a large substrate 288, as illustrated in FIG. 34, the primary element 308 and the secondary element 310 are unfolded to form the guide rail 298. A clamp 312 is provided to secure the guide rail 298 to the substrate 298.

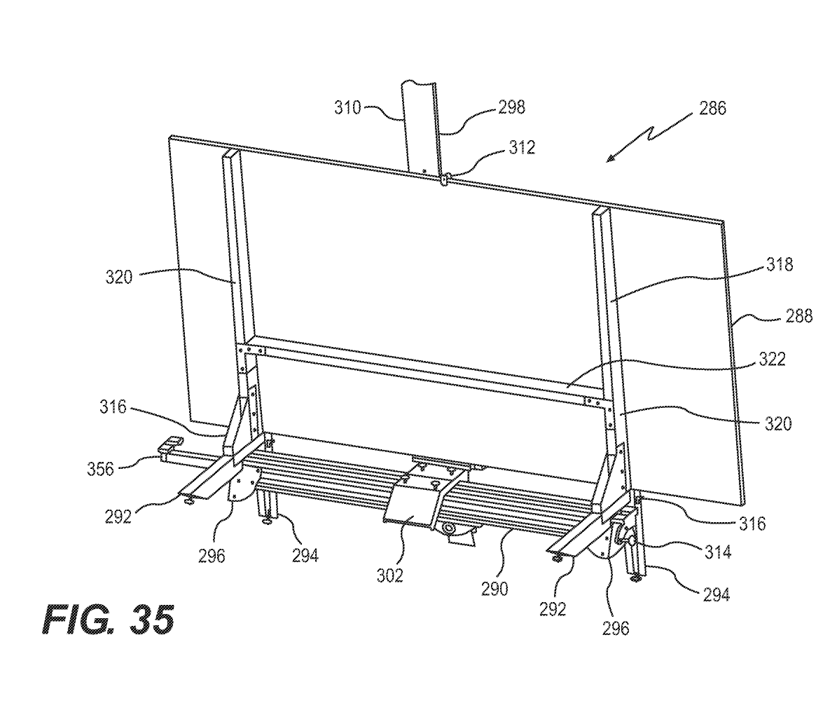

FIG. 35 is a rear view of the cutting guide 286 shown in FIG. 34. The carriage 302 is clearly visible in this illustration.

The cutting guide 286 includes a crank 314, which may be used to move the carriage 302 along the central rail 290.

As also illustrated in FIG. 35, the cutting guide 298 includes supports 316. The supports 316 are connected to one another by a frame 318, which serves as a support for the substrate 288. The supports 316 may positioned anywhere along the central support or rail 290. The frame 318, therefore, will have different sizes depending upon the positions of the supports 316.

In FIG. 35, the frame 318 includes two vertical elements 320 and a single horizontal element 322. As should be apparent, the number, size, and positioning of the elements 320, 322 are not critical for operation of the present invention. A larger or smaller number of elements 320, 322 may be employed without departing from the scope of the present invention.

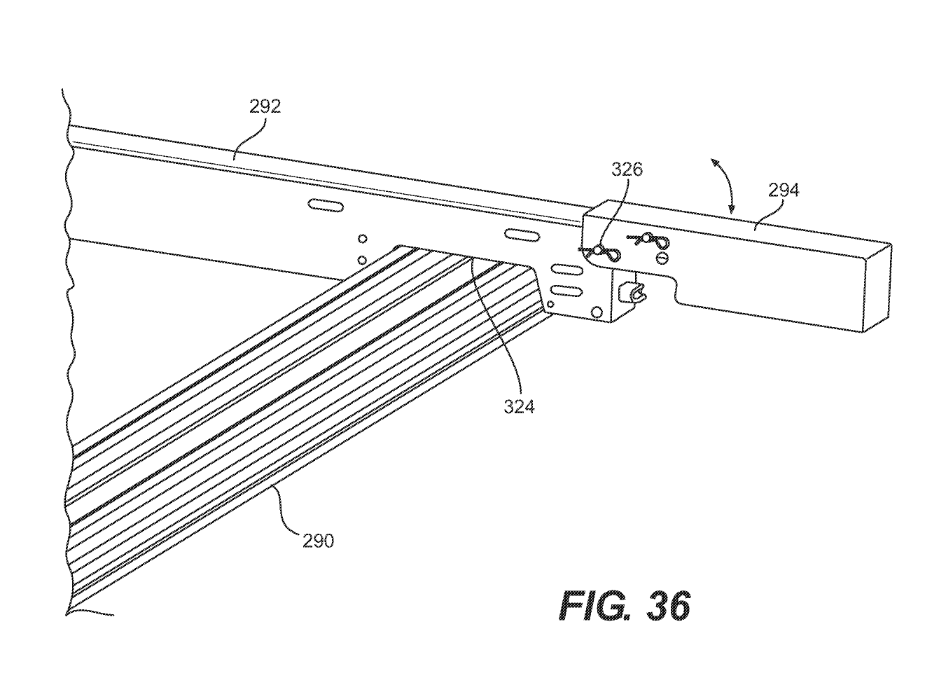

FIG. 36 illustrates an aspect of the legs 292, 294. Specifically, the legs 292, 294 are provided with a clamping function so that the legs 292, 294 may be easily removed from the central rail 290 for compact storage, for example. The movability of the legs 292, 294 also permits the user to adjust the relative positions of the supports 316 on the central rail 290.

With respect to FIG. 36, the rear leg 292 includes an indentation 324 that accepts or mates with the top surface of the central rail 290. The front leg 294 is shown in a position which is referred to as the opened position. Specifically, in this position, the legs 292, 294 are disengaged from the central rail 290. The front leg 294 pivots about a pivot axis 326.

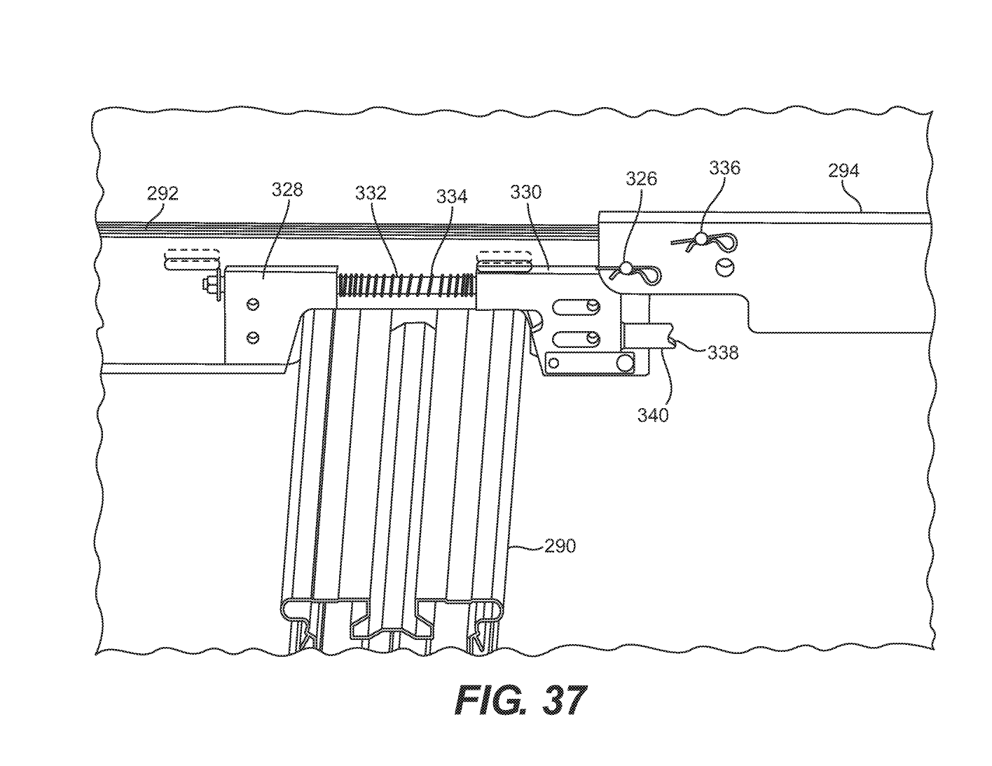

FIG. 37 provides an enlarged view of the mechanism that permits the legs 292, 294 to clamp onto a selected position on the central rail 290. This illustration shows the legs 292, 294 in an unlocked position.

The mechanism that permits the legs 292, 294 to attach to the central rail 290 includes two clamping chucks 328, 330 that are mounted on a common axle 332 and are biased to move away from one another by a biasing member 334, such as a spring. Therefore, when the front leg 294 is in the unlocked position, as illustrated in FIG. 37, the chucks 328, 330 move outwardly from the central rail 290 so that the legs 292, 294 disengage from the central rail 290.

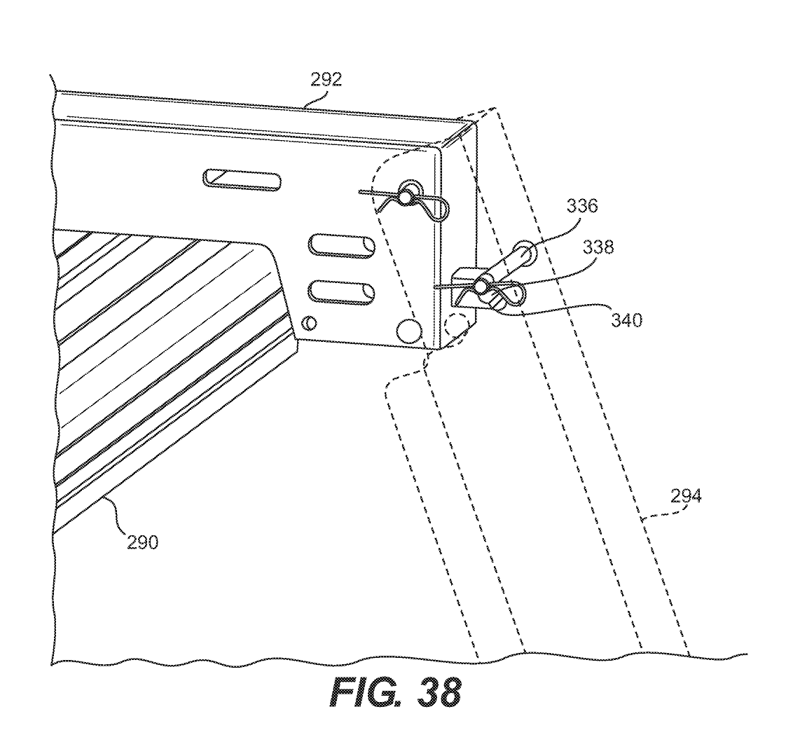

FIG. 38 illustrates a position of the front leg 294 at a moment prior to the front leg 294 becoming locked with the rear leg 292, thereby clamping the legs 292, 294 onto the central rail 290. As illustrated, the front leg 294 includes a dowel 336 that engages a detent 338 in a push rod 340. As the front leg 294 pushes the push rod 340, the push rod 340 applies pressure against the chuck 330, which causes the chucks 328, 330 to engage the central rail 290.

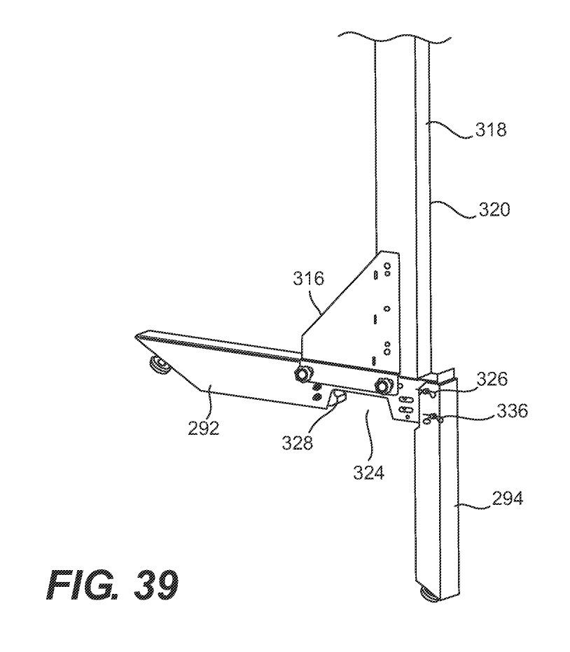

FIG. 39 illustrates one of the supports 316 together with the frame 318 connected to the legs 292, 294. As illustrated, the support 316 connects to the rear leg 292 at a position above the indentation 324. As should be appreciated from the drawings, the front leg 294 releasably engages the rear leg 292 when in the locked position, thereby establishing a V-shaped structure that supports a substrate 288 placed on the cutting guide 286.

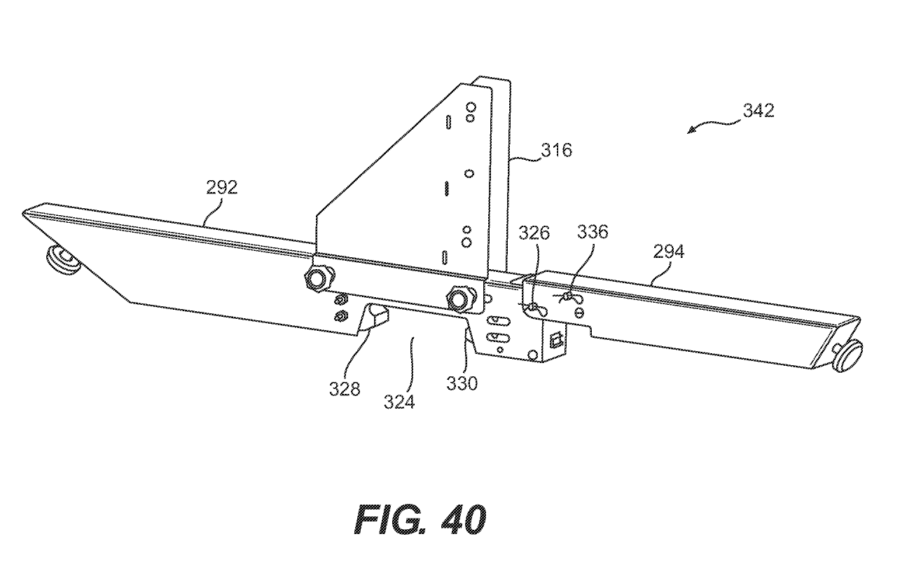

FIG. 40 is an illustration of the end support structure 342 that includes the legs 292, 294 and shows the supports 316 that connect to the frame 318, as shown in FIG. 39. As is apparent, the frame 318 has been omitted from this illustration for ease of understanding. As discussed, the legs 292, 294 are shown in an unlocked position.

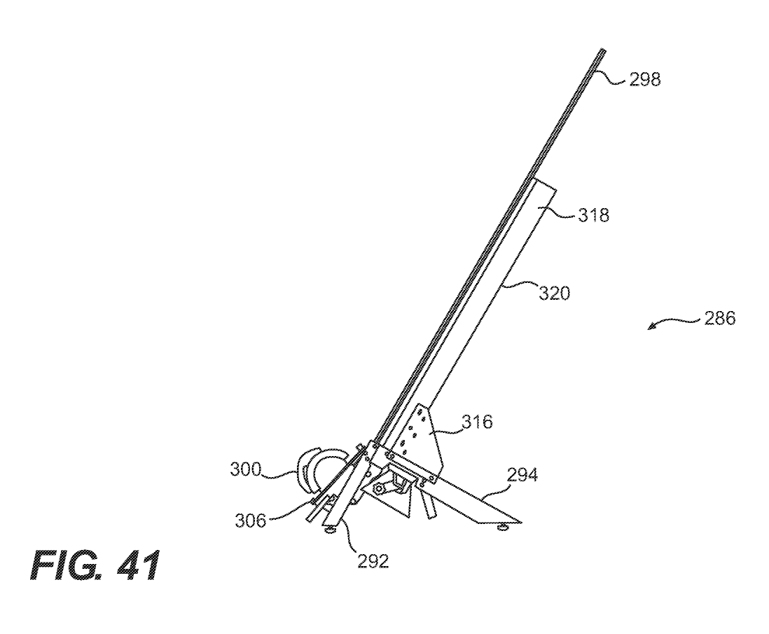

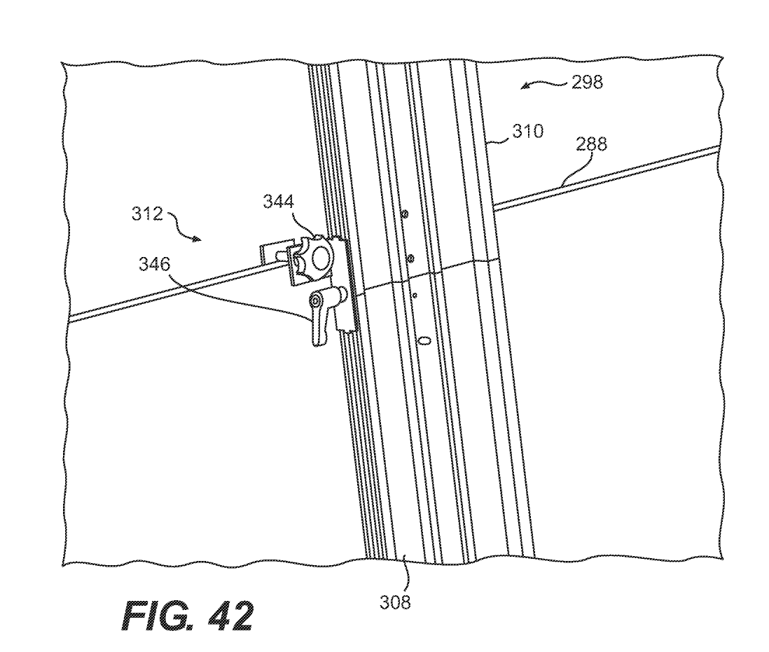

FIG. 41 is a side view of the cutting guide 286 of this embodiment of the present invention.

FIG. 42 is an enlarged, perspective of the damping device 312. The damping device 312 includes a knob 344 that permits the clamping device 312 to be secured to the substrate 298. The lever 346 permits the damping device 312 to be fixed along the guide rail 298 at a suitable position for the size of the substrate 288.

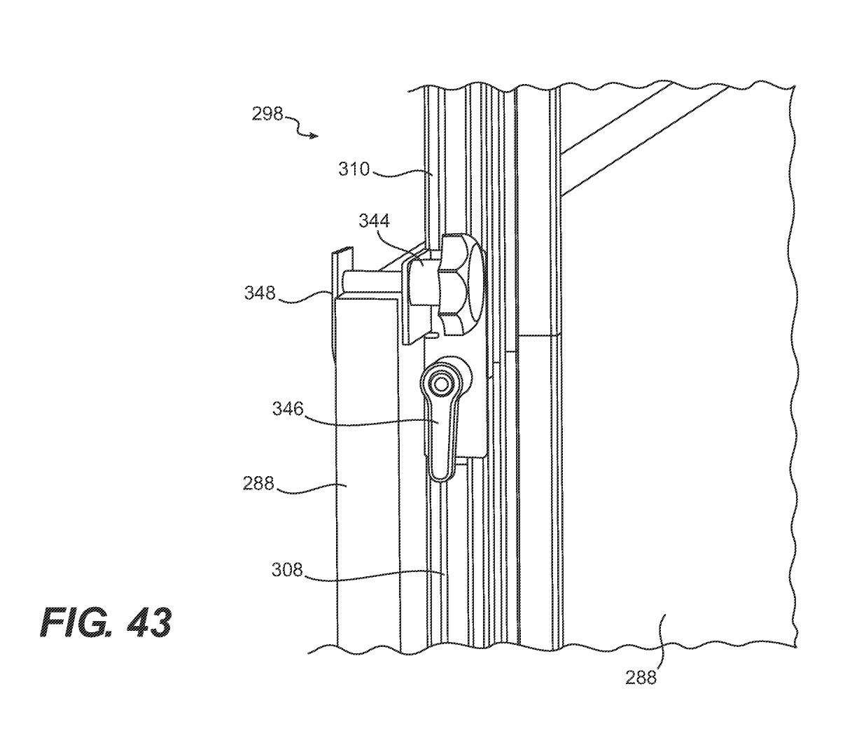

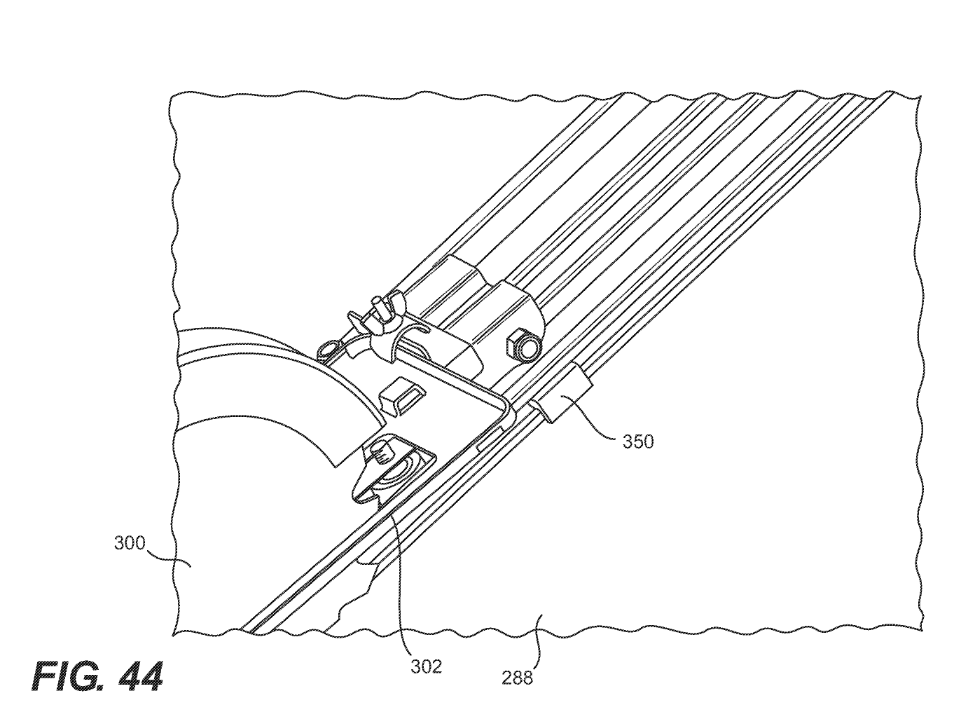

FIG. 43 is an illustration of the clamping device 312 from a slightly different perspective, showing a finger plate 348 connected to the knob 344 to secure the guide rail 298 securely against the substrate 288.

FIG. 44 is a perspective illustration of a portion of the rail guide 298 with a forward portion of the carriage 302 on which the cutting device 300 is disposed. The carriage 302 includes a pointer 350 that provides a visual indication of the location of the cut being made by the cutting device 300.

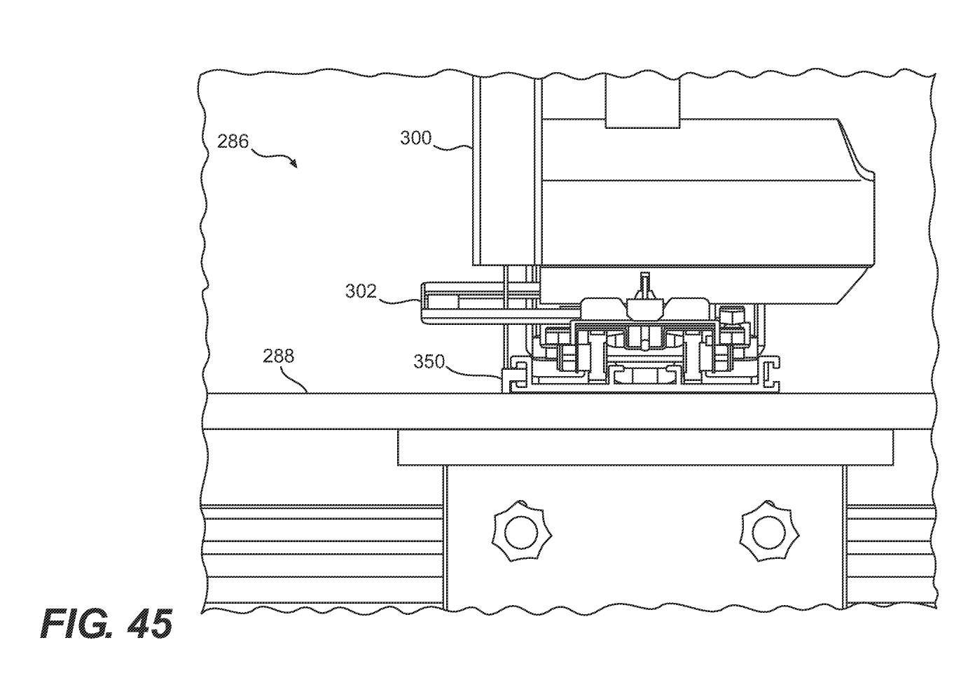

FIG. 45 is an end view of the portion of the cutting guide 298 of the present invention that is shown in FIG. 44.

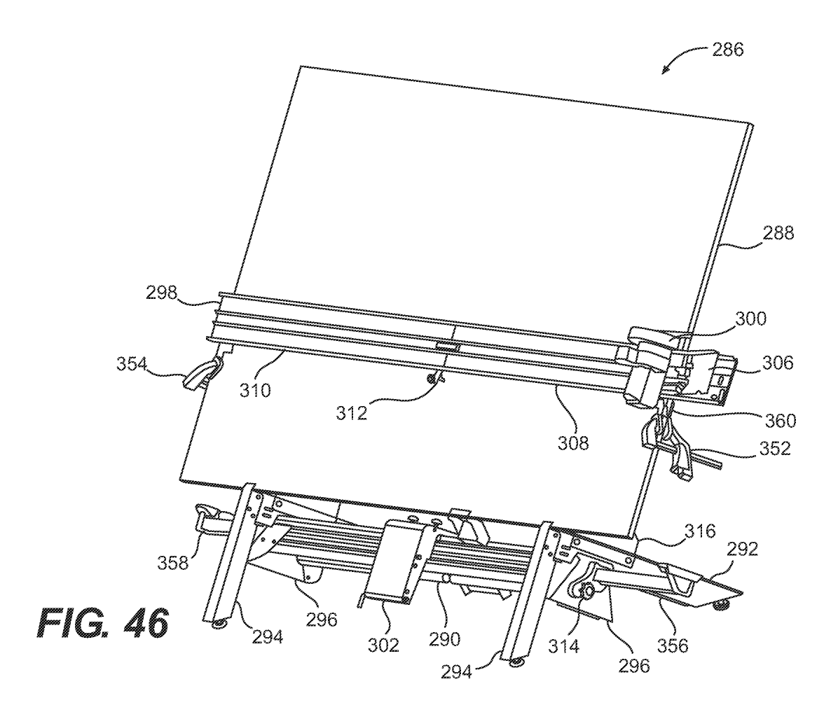

FIG. 46 is a perspective illustration of a further aspect of the cutting guide 286 of the present invention.

In the embodiments of the present invention that are discussed in the preceding paragraphs, the guide rail 298 is described as being rotatably connected to the carriage 302. In this embodiment of the cutting guide 286, the guide rail 298 is removable from the carriage 302 so that the guide rail 298 may permit cutting of the substrate 288 in a direction transverse to the axis of the central rail 290.

As illustrated in FIG. 46, the guide rail 298 has been disconnected from the carriage 302 and has been positioned on the substrate 288 to permit a horizontal cut of the substrate 288. As is apparent from the drawing, the primary element 308 and the secondary element 301 that make up the guide rail 298 are in the opened position so that they lie flat against the surface of the substrate 288.

To hold the guide rail 298 in a fixed position against the substrate 288, two clamps 352, 354 are provided at either end of the guide rail 298. The clamps 352, 354 hold the guide rail 298 in position while the user moves the cutting device 300 to cut the substrate 298.

FIG. 46 also illustrates another feature associated with the cutting guide 298. Specifically, the cutting guide 298 includes extenders 356, 358 that may be slid outwardly from either end of the central rail 290.

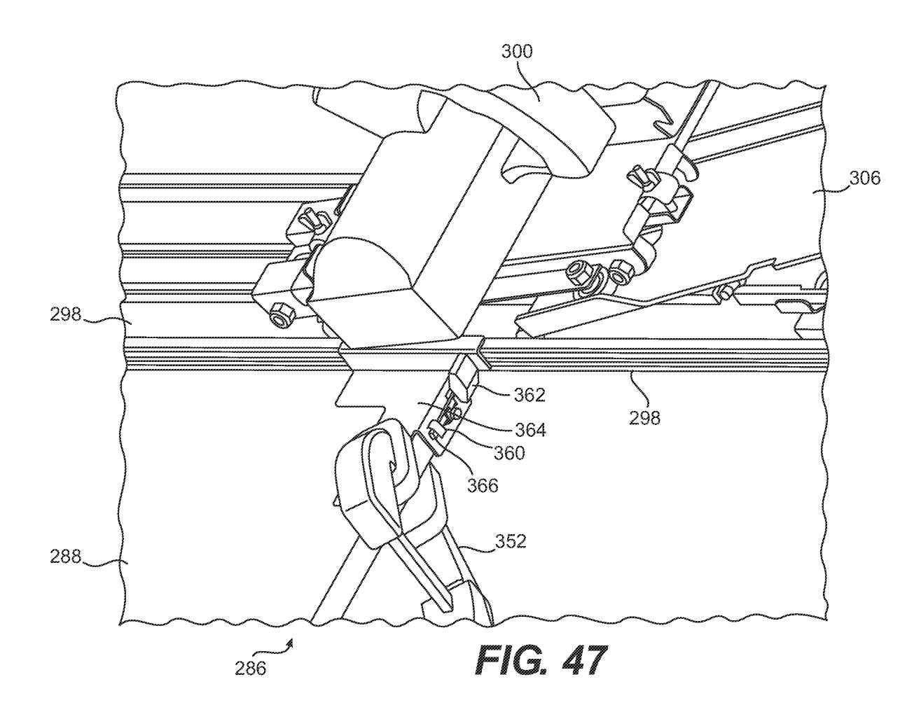

FIG. 47 is an enlarged perspective view of the cutting guide 298, arranged in the orientation illustrated in FIG. 46. This view illustrates a clamp extension 360, which is removably attached to the guide rail 298. The clamp extension includes a knob 362 that permits the extension 360 to be connected to the rail guide 298.

As shown in FIG. 47, the extension 360 defines an L-shaped plate 364 that abuts against the front surface of the substrate 288. The plate 364 provides sufficient surface area for the clamp 352 to secure the guide rail 298 to the front surface of the substrate 288.

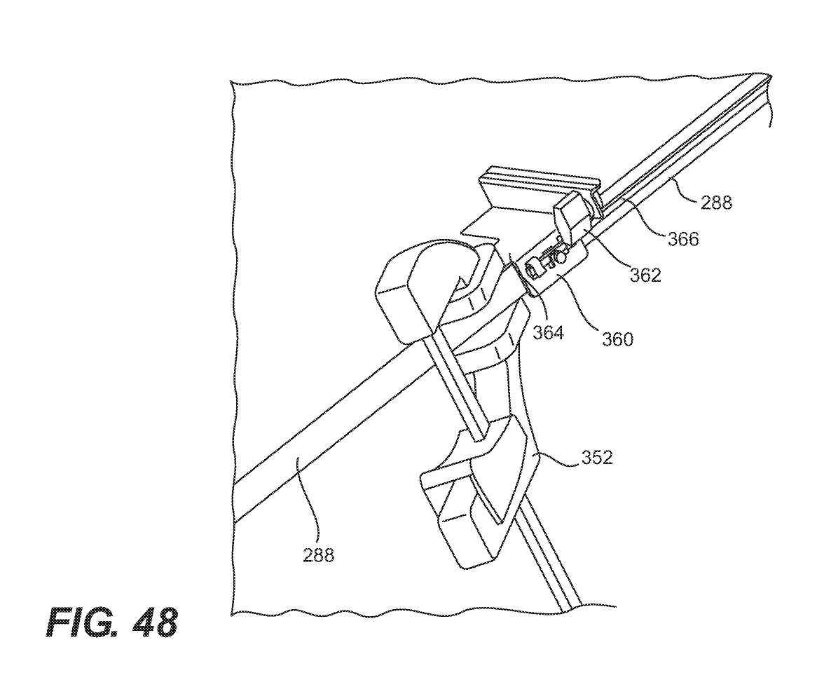

FIG. 48 is an enlarged, perspective view of the extension 360 that is illustrated in FIG. 47. Here, a securement bar 366 is more clearly visible. The securement bar 366 abuts against the edge of the substrate 288. It also may connect to the bottom surface of the guide rail 298. The securement bar 366 facilitates placement of the extension 360 in the appropriate position against the edge of the substrate 288, which helps to assure a reliable cut of the substrate 288.

As should be apparent from FIGS. 46-48, the rail guide 298 need not be positioned to be parallel to the central rail 290. To the contrary, it is contemplated that the guide rail 298 may be placed at any suitable angle without departing from the scope of the present invention.

With respect to the clamps 352, 354, it is noted that any suitable clamp may be employed without departing from the scope of the present invention. The clamp may be a screw-actuated clamp or a spring-biased clamp, among many other designs. As should be appreciated by those skilled in the art, the selection of the clamp will depend upon a variety of factors, which are to be determined during use of the cutting guide 286.

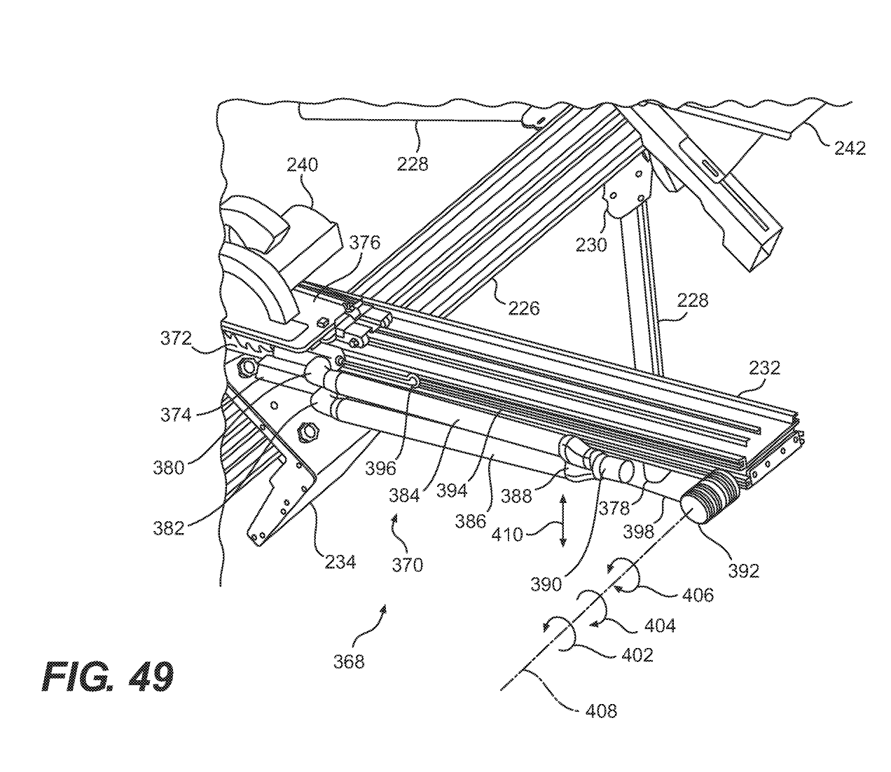

FIGS. 49-54 illustrate at least one further aspect of the present invention, embodiments of a dust removal apparatus that may be attached to embodiments of the cutting guide of the present invention. It is contemplated that a dust removal apparatus may be beneficial in instances where the substrate cut and/or shaped by the cutting device is one that generates dust. For example, the dust removal apparatus is contemplated to be helpful when cutting fiber cement siding, among other substrate materials. In such a case, the generation of dust at the location of the cutting of the substrate material may interfere with the user's ability to follow a cut line associated with the substrate material. As a result, by providing the dust removal apparatus, it is possible to direct the dust away from the cutting location during the cutting operation.

FIG. 49 is a perspective illustration of a further embodiment of a cutting guide 368 that includes one contemplated variation of a dust removal apparatus 370. To facilitate discussion of this embodiment, it is noted that the dust removal apparatus 370 has been added to the cutting guide 224 that is illustrated in FIG. 24. Accordingly, reference numerals that are employed to describe like features of the cutting guide 224 also are used for the cutting guide 368.

The dust removal apparatus 370 is connected adjacent to the guide rail 232. The dust removal apparatus 370 is designed to remove dust from the cutting location and redirect the dust to a location that is a distance from the cutting location. As noted above, this redirects the dust away from the cutting location to avoid, inter alia, visual obstruction of the cutting area.

The dust removal apparatus 370 includes an upper coupling 372 and a lower coupling 374. The upper coupling 372 connects to a side of the carriage 376. The lower coupling 374 engages the track 378 that is integrally formed as a part of the guide rail 232. Being connected to the carriage 376, the dust removal apparatus 370 slides along the side of the guide rail 232 as the carriage 376 moves atop to the guide rail 232.

The upper coupling 372 connects to an upper elbow 380. Similarly, the lower coupling 374 connects to a lower elbow 382. Dust that is generated by the cutting device 240 is collected by the upper and lower couplings 372, 374. The elbows 380, 382 redirect the dust into upper and lower discharge tubes 384, 386, respectively. In the illustrated embodiment, the discharge tubes 384, 386 are connected to a flow combiner 388. A discharge tube 390 extends outwardly from the flow combiner 388.

In the illustrated embodiment, operation of the cutting device 240 is anticipated to generate a sufficient velocity for the dust that the dust moves through the couplings 372, 374, the elbows 380, 382, through the discharge tubes 384, 386, and out from the discharge tube 390. While this is contemplated to be the arrangement for the dust removal apparatus 370, it is contemplated that the dust removal apparatus 370 may include a fan or other type of air mover to assist with discharge of the dust from the discharge tube 390.

With continued reference to FIG. 49, the dust removal apparatus 370 also includes a bobbin 392, which is attached to the track 378 of the guide rail 232. An upper line 394 connects between an upper eyelet 396 and the bobbin 392. A lower line 398 connects between a lower eyelet 400 and the bobbin 392. The upper and lower eyelets 396, 400 connect to the upper and lower couplings 372, 374.

In this embodiment, it is contemplated that the bobbin 392 is spring biased. As such, the bobbin 392 applies tension to and spools the upper and lower lines 394, 398. As shown in FIG. 49, the bobbin 392 may rotate in a counterclockwise direction 402, a clockwise direction 404, or both directions 406 around an axis of rotation 408. It is contemplated that, when the carriage 376 is moved by the operator of the cutting device 240 along the guide rail 232, the bobbin 392 maintains tension on the upper and tower lines 394, 398. In this manner, the bobbin 392 may be employed to assist with movement of the carriage 376 when the dust removal apparatus 370 is employed.

As also noted in FIG. 49, the upper and lower discharge tubes 384, 386 may be pivotally connected to the upper and lower couplings 372, 374 to permit motion along the direction of the arrow 410. Separately, the combiner 388 may be provided with a tab (not shown) that slides within the track 378. If so, the upper and lower discharge tubes 384, 386 are maintained in an essentially parallel orientation with respect to the guide rail 232. Still other variations are considered to fall within the scope of the present invention, as should be apparent to those skilled in the art.

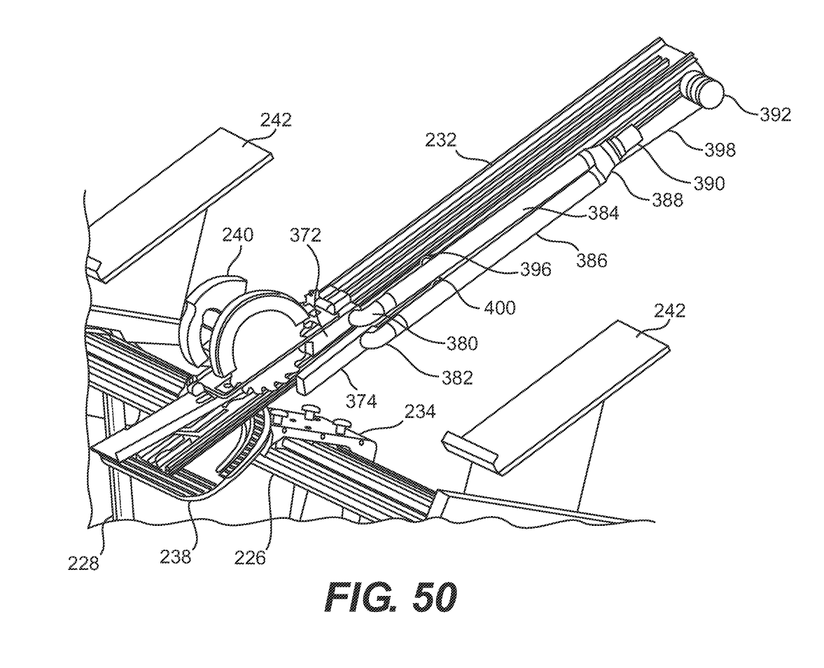

FIG. 50 is a perspective illustration of the cutting guide 368 shown in FIG. 49. This perspective is slightly different from the perspective in FIG. 49, thereby providing additional information about this embodiment. Specifically, the lower eyelet 400 is visible in this illustration.

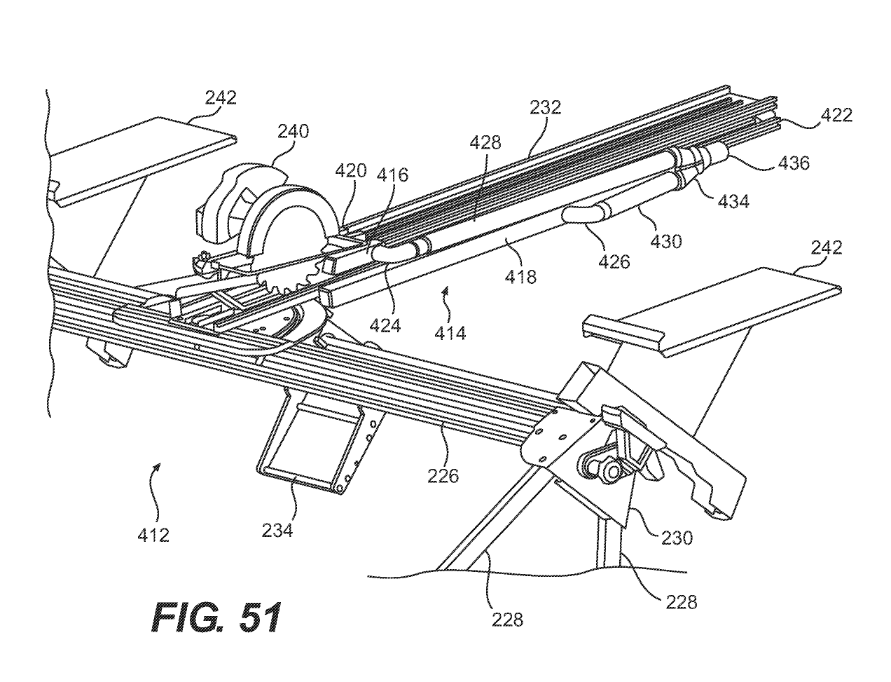

FIG. 51 is a perspective illustration of yet another embodiment of a cutting guide 412 according to the present invention. This embodiment is similar to the cutting guide 376 illustrated in FIGS. 49 and 50, except that the dust removal apparatus 414 is provided with a different construction from the dust removal apparatus 370.

The dust removal apparatus 414 includes upper and lower couplings 416, 418. The upper coupling 416 connects to one side of the carriage 420. The lower coupling 418 connects to a track 422 formed as a part of the guide rail 232. As before, an upper elbow 424 connects to the upper coupling 416. A lower elbow 426 connects to the lower coupling 418. An upper discharge tube 428 connects to the upper elbow 424. A lower discharge tube 430 connects to the lower elbow 426. As before, the upper discharge tube 428 and the lower discharge tube 430 meet at a combiner 434. The combiner discharges into a discharge tube 436.

This embodiment of the dust removal apparatus 414 differs from the prior embodiment in that the lower coupling 418 is longer than the lower coupling 374. In addition, the lower discharge tube 430 is shorter than the lower discharge tube 386. In addition, this embodiment excludes any bobbin arrangement.

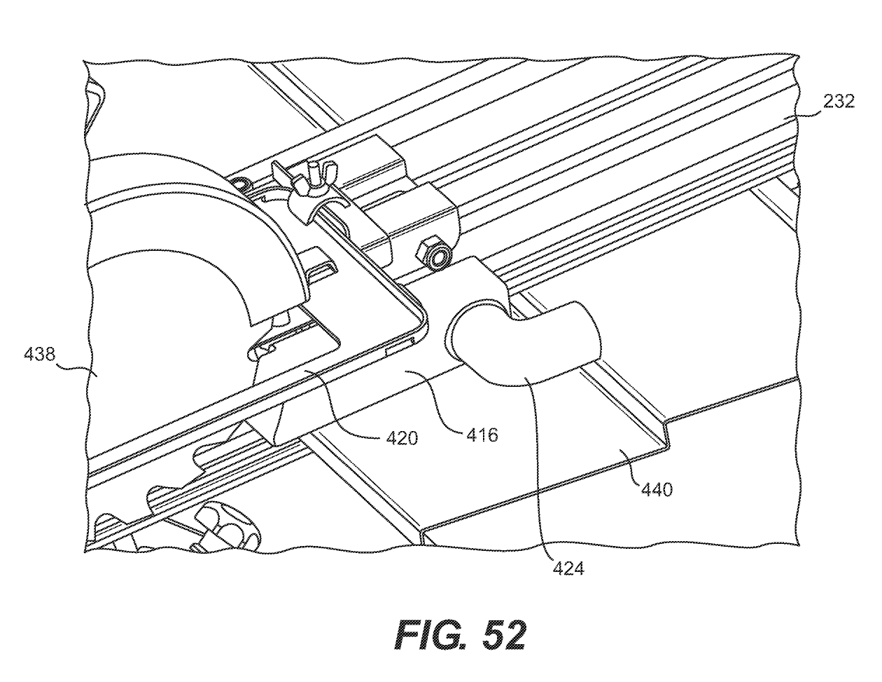

FIG. 52 is an enlarged, perspective, partial view of the dust removal apparatus 414 that is illustrated in FIG. 51. Here, the upper coupling 416 is shown connected to the carriage 420 adjacent to the blade 438 or equivalent cutting and/or shaping tool. Also illustrated is a substrate material 440, such as a piece of siding for a house. The substrate material 440 is to be cut by the blade 438. In FIG. 52, the upper elbow 424 also is visible. The upper discharge tube 428 is not shown in this view.

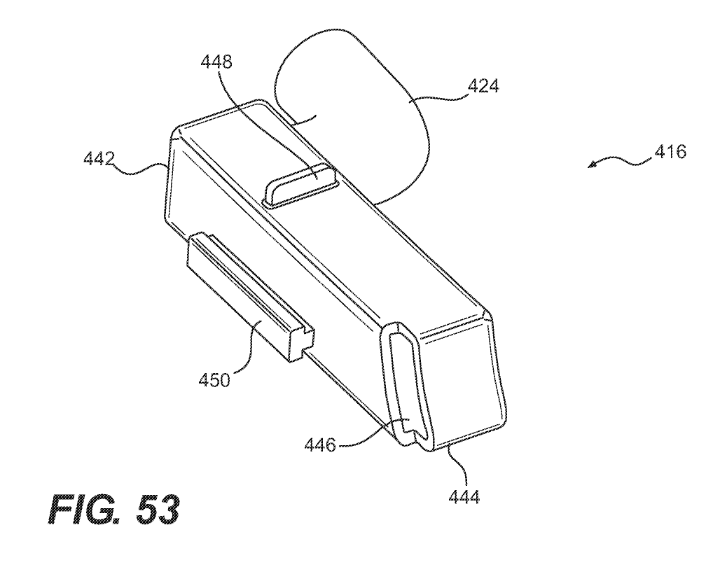

FIG. 53 is a perspective illustration of the upper coupling 416 that forms a part of the dust removal apparatus 414. The upper coupling has a front end 442 and a rear end 444. The front end 442 is contemplated to be closed off so that dust that flows through the upper coupling 416 exits through the upper elbow 424.

The rear end 444 of the upper coupling 416 includes an opening 446. The opening 446 is disposed adjacent to the blade 438 when the upper coupling 416 is connected to the carriage 420. The upper coupling 416 also may be provided with a tab 448 and a protrusion 450 so that the upper coupling 416 to facilitate securement to the carriage 420.

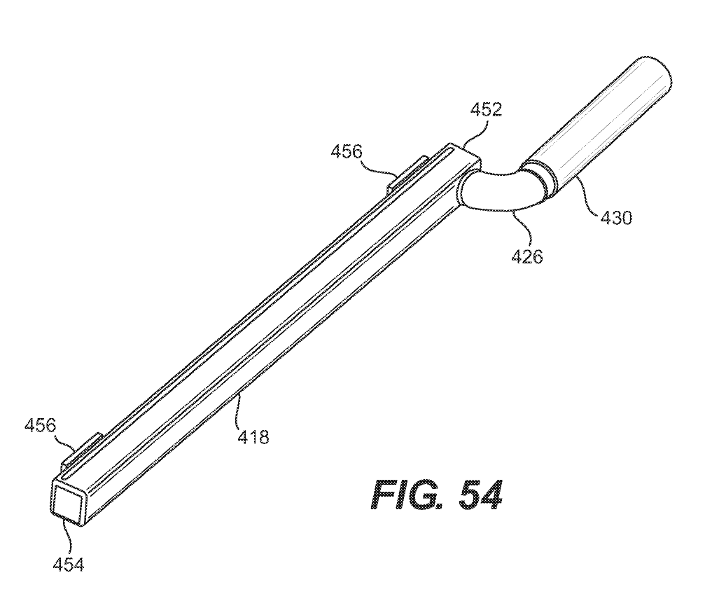

FIG. 54 is a perspective illustration of the lower coupling 418 of the dust removal apparatus 414 shown in FIG. 51. The lower coupling 418 has a front end 452 and a rear end 454, both of which are closed so that dust exits through the lower elbow 426 and the lower discharge tube 430. The lower coupling 418 includes one or more protrusions 456 that may slidingly engage the track 422 in the guide rail 232.

As with the upper coupling 416, the lower coupling 418 is contemplated to include an opening (not shown) in the rear end 454 so that dust may be introduced therewithin.

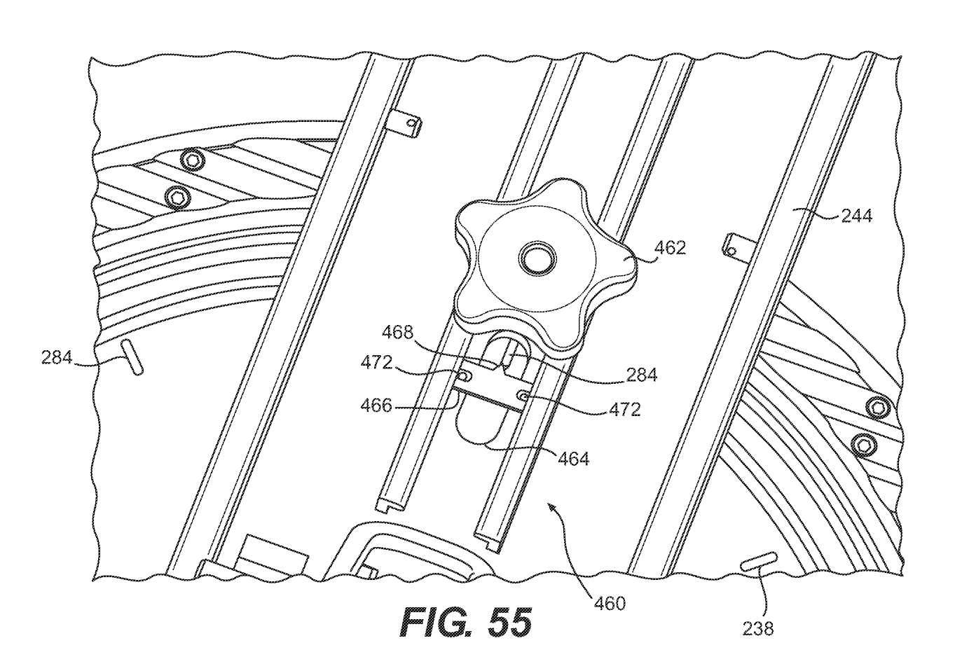

FIG. 55 is a perspective illustration of a further aspect of the present invention, which is a calibration mechanism 460. The calibration mechanism 460 is located on the primary element 244 adjacent to the adjustment knob 462.

As should be apparent, the adjustment knob 462 cooperates with the protractor 238 to adjust the position of the guide rail 232 to a predetermined angular position. For ease of reference, two of the angular markers or indicia 284 are shown in FIG. 55. The angular markers 284 provide an indication of the angular position of the guide rail 232 with respect to the protractor 238.

As should be apparent to those skilled in the art, it may become necessary to precisely position the guide rail 232 for an accurate cut of a particular substrate 288. Therefore, it may be necessary to have an accurate indication of the angular position of the guide rail 232. The calibration mechanism 460 includes a hole 464 in the primary element 244. The hole 464 permits the user to visually identify one or more indicia 284 therethrough.

As shown, an indicator bar 466 with a pointer 468 straddles the hole 464. The pointer is positioned such that, when the pointer 468 is aligned with one of the indicia 284, the pointer 468 properly identifies the angular displacement of the guide rail 232.

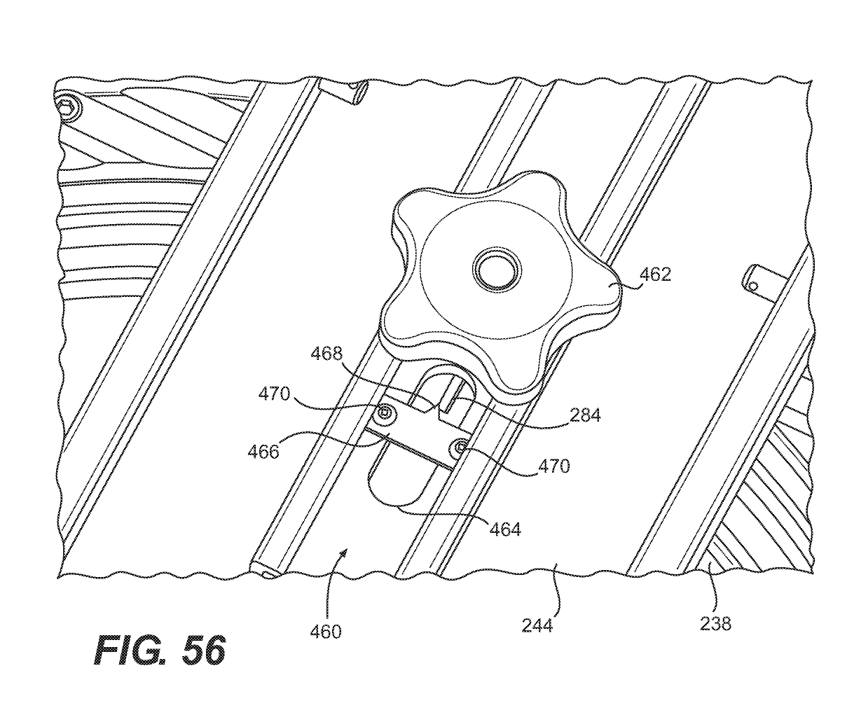

As indicated in FIGS. 55 and 56, the indicator bar 466 connects to the primary element 244 via two fasteners 470 that are disposed in respective holes 472 in the primary element 244. The indicator bar 466 is mounted such that it is permitted to move laterally between the fasteners 470. As a result, small corrections in any misalignment of the indicator bar 466 may be corrected by sliding the indicator bar 466 in either lateral direction. In this manner, the indicator bar 466 provides a means for calibrating the accuracy of the guide rail 232, as needed or as desired, by permitting realignment of the pointer 468.

It is contemplated that the accuracy of the protractor 238 may drift over time due to, among other factors, age, wear and tear, transportation impacts to the cutting guide, etc. It is for this reason, among others, that the calibration mechanism 460 is provided.

As should be apparent, other devices may be employed to accurately indicate the angular disposition of the guide rail 232. The present invention, therefore, is not intended to be limited by the embodiment of the calibration mechanism 460 described herein.

Additionally, it is contemplated that the cutting guide may include one or more devices that permit the user to accurately set the guide rail 232 at any predetermined or selected angle.

The various embodiments of the cutting guide of the present invention have been discussed in connection with the cutting of various substrate materials including, but not limited to, wood, plywood, sheet rock, metal siding, vinyl siding, and the like. As should be apparent to those skilled in the art, other substrate materials also may be cut using the cutting guide of the present invention.

It is contemplated, for example, that one or more of the embodiments of the present invention may be used to cut concrete or other masonry materials. In addition, the present invention may be employed to cut tiles or other ceramic materials. Finally, the present invention may be used to cut metal materials, composite materials, polymer materials, plastics, and the like. The number of different materials that may be cut using the present invention is too great to provide an exhaustive list herein.

In connection with one or more substrate materials, it is contemplated that it may be necessary to supply a cooling fluid and/or a lubricant to a position where the cutting occurs. The cooling fluid and/or lubricant may be water, oil, or any suitable alternative. The cooling and/or lubricating fluid may be applied to the blade or cutting tool. Alternatively, the cooling and/or lubricating fluid may be applied on or near to the location where the substrate material is being cut.

There are many ways in which the cooling and/or lubricating fluid may be transported to the cutting location. In one simple example, the fluid may be provided by way of a tube or hose from a reservoir. A nozzle may be provided to control the precise location where the fluid is applied. The fluid may be pressurized or unpressurized (i.e., gravity-fed). Where the fluid is pressurized, one or more pumps may be employed to pressurize the fluid. Separately, the reservoir may be pressurized via a gas, such as air or nitrogen (among other gases), to assist with delivery of the fluid to a predetermined location.

Where the cooling and/or lubricating fluid acts as a coolant, the fluid may be chilled to a suitable temperature before being delivered to the cutting location. The fluid may be cooled via a suitable chiller or other device, as should be apparent to those skilled in the art.

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A cutting guide, comprising:
a central support;
a plurality of legs supporting the central support;
a removable guide rail disposed on the central support, wherein the guide rail defines a first end and a second end; and
a carriage slidably disposable in the guide rail,
wherein the carriage is adapted to receive a cutting device thereon and the carriage is disposable within the guide rail to be movable between the first end and the second end.

2. The cutting guide of claim 1, wherein the guide rail comprises:
a body with a top surface, a first side edge, and a second side edge;
a first side extending upwardly from the top surface of the guide rail adjacent the first side edge; and
a second side extending upwardly from the top surface adjacent to the second side edge,
wherein the body, the first side and the second side define a U-shaped channel for receipt of the carriage.

3. The cutting guide of claim 2, wherein:
the first side extends upwardly from the top surface at the first side edge of the guide rail; and
the second side extends upwardly from the top surface at the second side edge at a predetermined distance toward a center of the guide rail from the second edge,
wherein the second side and the second side edge define a cutting guide thereby.

4. The cutting guide of claim 2, wherein the guide rail further comprises:
a first channel defined within the first side; and
a second channel defined within the second side.

5. The cutting guide of claim 4, further comprising:
an extension comprising an end segment connecting a first leg and a second leg to one another forming a U-shape,
wherein the first and second legs are positioned within the first and second channels, permitting the extension to slidably engage the guide rail.

6. The cutting guide of claim 1, further comprising:
a guide carriage slidably disposed on the central support,
wherein the guide rail is pivotally connected to the guide carriage to permit the guide rail to be angularly positioned with respect to the central support.

7. The cutting guide of claim 1, further comprising:
a first upright connected to the central support at a first end; and
a second upright connected to the central support at a second end,
wherein the first and second uprights are angled with respect to horizontal such that a construction material place thereon is angled with respect to the horizontal.

8. The cutting guide of claim 7, further comprising:
at least one horizontal frame element connected between the first upright and the second upright, thereby forming a frame connected to the central support.

9. The cutting guide of claim 2, further comprising:
a first lip extending from a top edge of the first side toward a center of the guide rail; and
a second lip extending from a top edge of the second side toward the center of the guide rail,
wherein the first and second lips retain the carriage within the guide rail.

10. The cutting guide of claim 1, wherein the central support, the legs, the guide rail, and the carriage are made from at least one a material selected from a group comprising aluminum, aluminum alloys, metal, plastic, fiberglass, composite materials, steel, iron, iron alloys, titanium, titanium alloys, magnesium, magnesium alloys, beryllium, beryllium alloys, carbon fiber, and aramid fiber.

11. The cutting guide of claim 6, further comprising:
a protractor disposed between the guide rail and the guide carriage to provide an indication of an angle of displacement of the guide rail with respect to a vertical position.

12. The cutting guide of claim 1, wherein the guide rail comprises:
a primary element; and
a secondary element hingedly connected to the primary element such that the secondary element folds over the primary element when in a closed position and unfolds adjacent to the primary element when in an opened position.

13. The cutting guide of claim 12, further comprising:
a latch disposed on the guide rail to secure the secondary element against the primary element when in the closed position.

14. The cutting guide of claim 1, further comprising:
a ramp disposed at one end of the guide rail,
wherein the ramp is adjustable to a predetermined angle with respect to the guide rail, and
wherein the ramp facilitates introduction of the cutting device to the guide rail.

15. The cutting guide of claim 1, further comprising:
a dust removal apparatus comprising
an upper coupling connected to the carriage, the upper coupling defining an upper opening at one end,
a lower coupling connected adjacent to the upper coupling, the lower coupling defining a lower opening at one end, consistent with the upper opening,
an upper discharge tube connected to the upper coupling,
a lower discharge tube connected to the lower coupling, and
a combiner connecting the upper discharge tube to the lower discharge tube, such that dust flowing through the upper and lower discharge tubes exits via the combiner.

16. The cutting guide of claim 1, further comprising:
at least one extension slidably connected to the guide rail, the at least one extension comprising at least one plate providing a surface area for securement of the guide rail to the substrate via a fastener.

17. The cutting guide of claim 1, wherein:
the plurality of legs comprise at least two front legs and two rear legs,
each front leg is connected pivotally to each rear leg,
the front and rear legs are connected operatively to two chucks, which cooperate with one another to secure the front and rear legs to the central support when the legs are in a closed position and which cooperate with one another to release the front and rear legs from the central support when in an opened position.

18. The cutting guide of claim 17, further comprising:
a push rod, operatively connected to the two chucks, for applying a compressive force on the two chucks when the front and rear legs are in the closed position.

19. The cutting guide of claim 1, further comprising:
at least one extender slidably disposed within one end of the central support,
wherein the extender may be slid out from the central support to extend a length of the central support.
